(19) United States
(12) Patent Application Publication
(10) Pub. No.: US 2015/0015826 A1
(43) Pub. Date: Jan. 15, 2015

(54) LIQUID CRYSTAL DISPLAY DEVICE AND METHOD FOR MANUFACTURING SAME

(71) Applicant: Sharp Kabushiki Kaisha, Osaka-shi, Osaka (JP)

(72) Inventor: Masanobu Mizusaki, Osaka-shi (JP)

(21) Appl. No.: 14/370,296

(22) PCT Filed: Jan. 7, 2013
(86) PCT No.: PCT/JP2013/050047

§ 371 Date: Jul. 2, 2014

(30) Foreign Application Priority Data
Jan. 6, 2012 (JP) 2012-001640

(51) Int. Cl. G02F 1/1337

(52) U.S. Cl. CPC G02F 1/133711; G02F 1/133788
USPC 349/61; 349/123; 349/106; 445/24

(57) ABSTRACT

The present invention provides a liquid crystal display device that can suppress image sticking, ensure the long-term reliability, and improve the display quality; and a method of producing the same. The present invention provides a liquid crystal display device including: a first substrate; a second substrate; a photoalignment film provided on at least one of the first and second substrates; a polymer layer provided on the photoalignment film; and a liquid crystal layer provided between the first and second substrates, the polymer layer containing a polymer having a monomer unit derived from two or more kinds of polymerizable monomers, the two or more kinds of polymerizable monomers including at least a monomer that increases the polymerization rate as compared with a conventional case and a monomer that improves the residual DC voltage and prevents lowering of the VHR.

### TECHNICAL FIELD

The present invention relates to a liquid crystal display device and a method for producing the same. More specifically, the present invention relates to a liquid crystal display device including a photoalignment film and a polymer layer provided on the alignment film, and a method for producing the same.

### BACKGROUND ART

A liquid crystal display device is a display device in which the alignment of liquid crystal molecules is controlled by adjusting the applied voltage so that transmission/blocking of light (ON/OFF of display) is controlled. Commonly, a liquid crystal display device has a pair of substrates each having an alignment film and a liquid crystal layer provided between the pair of substrates.

Rubbing treatment of an alignment film (rubbing method) is well known as alignment treatment of an alignment film. A recently developed technique is alignment treatment by irradiating an alignment film with light such as UV light (hereafter, also referred to as “photoalignment technique”). The photoalignment technique enables to control the initial alignment of liquid crystal molecules without performing rubbing treatment on the alignment film. An alignment film resulting from the alignment treatment by the photoalignment technique is also referred to as a photoalignment film.

Light in the present description refers not only to visible light but also to, for example, light including UV light.

The technique also considered is a technique for improving the properties such as the response time and long-term reliability, in which a liquid crystal layer containing a polymerizable compound such as a polymerizable monomer (hereafter, also simply referred to as a “monomer”) and a polymerizable oligomer is formed between a pair of substrates and the polymerizable compound is polymerized in the liquid crystal layer to form a layer containing a polymer on the alignment film (hereafter, also referred to as “PSA (Polymer Sustained Alignment)” technique).

A technique combining the photoalignment and PSA is also considered. For example, a disclosed liquid crystal display device includes a liquid crystal layer, a photoalignment film, and an alignment-sustaining layer containing a polymer provided between the liquid crystal layer and the photoalignment film (see Patent Literature 1).

### CITATION LIST

### Patent Literature

### Patent Literature 1: WO 2009/157207

### SUMMARY OF INVENTION

### Technical Problem

A liquid crystal display device including a photoalignment film has a large residual DC voltage and easily has image sticking (afterimage), and also has insufficient long-term reliability. The present inventors have confirmed that the PSA technique is an effective measure against image sticking of such a liquid crystal display device.

The image sticking is a phenomenon that, after display of one image for a certain period of time, the image is faintly left even after the displayed image is changed.

In a case where a monomer is polymerized with UV irradiation, the initial alignment of liquid crystal molecules may be unintendedly changed. More specifically, the pretilt angle may be changed and the direction of the initial alignment (hereafter, also simply referred to as the “initial alignment direction”) may be disturbed. The reason for such phenomenon is presumably that the photoalignment film commonly has a photoreactive functional group and the photoreactive functional group commonly reacts with UV light that is for polymerization of monomers. Such a change may cause reduction in the display quality such as deterioration of the viewing angle characteristic and lowering of the contrast.

To solve the problem, reduction in the UV irradiation dose may be considered. In such a case, however, polymerization of monomers may be insufficient, possibly resulting in the increased residual DC voltage and the lowered long-term reliability.

Here, with reference to FIGS. 13(a) to 13(e), a description is given on a method of producing a liquid crystal display device of a horizontal alignment type according to Comparative Embodiment 1.

First, a pair of substrates 110 and 120 are provided.

Next, the step of forming an alignment film is conducted. Specifically, as shown in FIG. 13(a), photoalignment films 111 and 121 are formed on the substrates 110 and 120, respectively. The photoalignment films 111 and 121 each have a photoreactive functional group.

Then, the step of performing photoalignment treatment is conducted. Specifically, as shown in FIG. 13(b), alignment treatment is performed on the photoalignment films 111 and 121 by irradiating the photoalignment films 111 and 121 with polarized UV light 131 having a polarization axis in a direction of the bidirectional arrow in FIG. 13(b).

Subsequently, the step of forming a liquid crystal panel is conducted. Specifically, as shown in FIG. 13(c), the substrates 110 and 120 set to face each other are bonded. A liquid crystal composition containing liquid crystal molecules 141 and a polymerizable monomer 142 is injected between the substrates 110 and 120 to form a liquid crystal layer 140. The monomer 142 used may be a monomer represented by a formula in Reaction Formula (a) mentioned below.

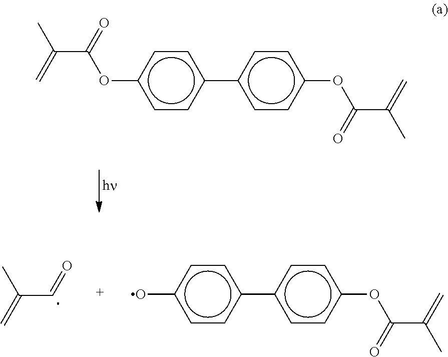

Finally, a polymerization step is conducted. Specifically, as shown in FIG. 13(d), the liquid crystal layer 140 is irradiated with UV light 132 (non-polarized light) from the outside of the liquid crystal panel. At that time, as indicated by Reaction Formula (a), a photo-fries rearrangement occurs in the monomer 142 to generate a radical. The generated radical becomes a starting point of the polymerization reaction. As a result, as shown in FIG. 13 (e), a layer containing polymers (polymer layer) is formed on each of the photoalignment films 111 and 121. In this process, as mentioned above, photoreactive functional groups in the photoalignment films 111 and 121 also react with the UV light 132. Accordingly, in the liquid crystal display device of a horizontal type according to Comparative Embodiment 1, the initial alignment direction of the liquid crystal molecules 141 changes to lower the contrast.

Patent Literature 1 discloses a technique of suppressing occurrence of image sticking by controlling the change of the pretilt angle after voltage application in a liquid crystal display device of the vertical alignment type. In this technique, however, only monomers that start polymerization by the photo-fries rearrangement are used. Therefore, there is still room to reduce image sticking and to improve the display quality and long-term reliability. Patent Literature 1 does not refer to a liquid crystal display device of the horizontal alignment type.

The present invention has been devised in consideration of the state of the art, and aims to provide a liquid crystal display device that can suppress image sticking, secure the long-term reliability, and improve the display quality; and a method of producing the same.

### Solution to Problem

The present inventors intensively studied the liquid crystal display device that can suppress image sticking, secure the long-term reliability, and improve the display quality, and focused on monomers for forming a polymer layer. The present inventors found out the following fact. Since the radical generation efficiency by the photo-fries rearrangement is low, the polymerization rate in Comparative Embodiment 1 is not enough. The use of two or more kinds of polymerizable monomers including a polymerizable monomer represented by Formula (I) and a polymerizable monomer represented by Formula (II) increases the polymerization rate, suppresses a change in the initial alignment of liquid crystal molecules, reduces the residual DC voltage, and maintains the high voltage holding ratio (VHR) for a longtime. Accordingly, the present inventors solved the above problem and arrived at the present invention.

Specifically, the first aspect of the present invention provides a liquid crystal display device (hereafter, also referred to a device according to the present invention) including: a first substrate; a second substrate; a photoalignment film provided on at least one of the first and second substrates; a polymer layer provided on the photoalignment film; and a liquid crystal layer provided between the first and second substrates, the polymer layer containing a polymer having a monomer unit derived from two or more kinds of polymerizable monomers, the two or more kinds of polymerizable monomers including at least a polymerizable monomer represented by Formula (I):

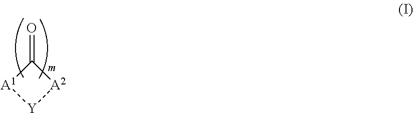

wherein A¹ and A² may be the same as or different from each other and each represent a benzene ring, biphenyl ring, or C1-C12 linear or branched alkyl or alkenyl group, one of A¹ and A² represents a benzene or biphenyl ring, at least one of A¹ and A² include a -Sp¹-P¹ group, a hydrogen atom on A¹ and A² may be replaced by a -Sp¹-P¹ group, halogen atom, —CN group, —NO₂ group, —NCO group, —NCS group, —OCN group, —SCN group, —SF₅ group, or C1-C12 linear or branched alkyl, alkenyl, or aralkyl group; two hydrogen atoms bonded to two adjacent carbons in A¹ and A² may be replaced by a C1-C12 linear or branched alkylene or alkenylene group to form a ring structure; a hydrogen atom on the alkyl, alkenyl, alkylene, alkenylene, or aralkyl group in A¹ and A² may be replaced by a -Sp¹-P¹ group; a —CH₂— group on the alkyl, alkenyl, alkylene, alkenylene, or aralkyl group in A¹ and A² may be substituted with a —O—, —S—, —NH—, —CO—, —COO—, —OCO—, —O—COO—, —OCH₂—, —CH₂O—, —SCH₂—, —CH₂S—, —N(CH₃)—, —N(C₂H₅)—, —N(C₃H₇)—, —N(C₄H₉)—, —CF₂O—, —OCF₂—, —CF₂S—, —SCF₂—, —N(CF₃)—, —CH₂CH₂—, —CH₂CF₂—, —CF₂CH₂—, —CF₂CF₂—, —CH═CH—, —CF═CF—, —C≡C—, —CH═CH—COO—, or —OCO—CH═CH— group, provided that oxygen, sulfur, and nitrogen atoms are not adjacent to one another; P¹ represents a polymerizable group; Sp¹ represents a C1-C6 linear, branched, or cyclic alkylene or alkyleneoxy group or a direct bond; m represents 1 or 2; a dotted line between A¹ and Y and a dotted line between A² and Y represent an optional bond between A¹ and A² via Y; Y represents a —CH₂—, —CH₂CH₂—, —CH═CH—, —O—, —S—, —NH—, —N(CH₃)—, —N(C₂H₅)—, —N(C₃H₇)—, —N(C₄H₉)—, —OCH₂—, —CH₂O—, —SCH₂—, or —CH₂S— group or a direct bond, and a polymerizable monomer represented by Formula (II):

P³—S³-A³-(Z³-A⁴)ₙ-S⁴—P⁴ (I)

wherein P³ and P⁴ may be the same as or different from each other, and each represent an acryloyloxy, methacryloyloxy, acryloylamino, methacryloylamino, vinyl, or vinyloxy group; A³ and A⁴ may be the same as or different from each other, and each represent a 1,4-phenylene, 4,4′-biphenyl, naphthalene-2,6-diyl, phenanthrene-2,7-diyl, phenanthrene-3,6-diyl, phenanthrene-3,8-diyl, or phenanthrene-1,8-diyl group; Z³ may be the same as or different from each other, and each represent a —COO—, —OCO—, —O—, —CO—, —NHCO—, —CONH—, or —S— group or a direct bond between A³ and A⁴ or between A⁴ and A⁴; n represents 0, 1, 2, or 3; S³ and S⁴ may be the same as or different from each other, and each represent a —(CH₂)ₘ— group (m representing a natural number satisfying 1≦m≦6), a —(CH₂—CH₂—O)ₘ— group (m representing a natural number satisfying 1≦m≦6), or a direct bond between P³ and A³, between A³ and P⁴, or between A⁴ and P⁴; and a hydrogen atom on A³ and A⁴ may be replaced by a halogen or methyl group.

The device according to the present invention is not especially limited by other components as long as it essentially includes such components.

The second aspect of the present invention provides a method (hereafter, also referred to as a production method according to the present invention) of producing a liquid crystal display device, including the steps of: providing a first substrate and a second substrate; forming a photoalignment film on at least one of the first and second substrates; forming a liquid crystal layer containing two or more kinds of polymerizable monomers between the first and second substrates after the formation of the photoalignment film; and forming a polymer layer on the photoalignment film by polymerizing the two or more kinds of polymerizable monomers, wherein the two or more kinds of polymerizable monomers include at least a polymerizable monomer represented by Formula (I) and a polymerizable monomer represented by Formula (II).

The production method according to the present invention is not especially limited by other steps as long as it essentially includes such steps.

In the method according to the present invention, when to perform the alignment treatment on the photoalignment film is not particularly limited and may be determined as appropriate. Accordingly, in the production method according to the present invention, “after formation of the photoalignment film” may be before or after the alignment treatment of the photoalignment film. In addition, the liquid crystal layer may be formed before or after the alignment treatment of the photoalignment film. For example, the alignment treatment of the photoalignment film may be performed concurrently with polymerization of the polymerizable monomers.

A description is given on preferable embodiments of the device and the method according to the present invention. The following preferable embodiments may be combined as appropriate, and such an embodiment including two or more preferable embodiments combined with each other is also a preferable embodiment.

The polymerizable monomer represented by Formula (I) may be a polymerizable monomer represented by any one of Formulae (I-1) to (I-6) mentioned below;

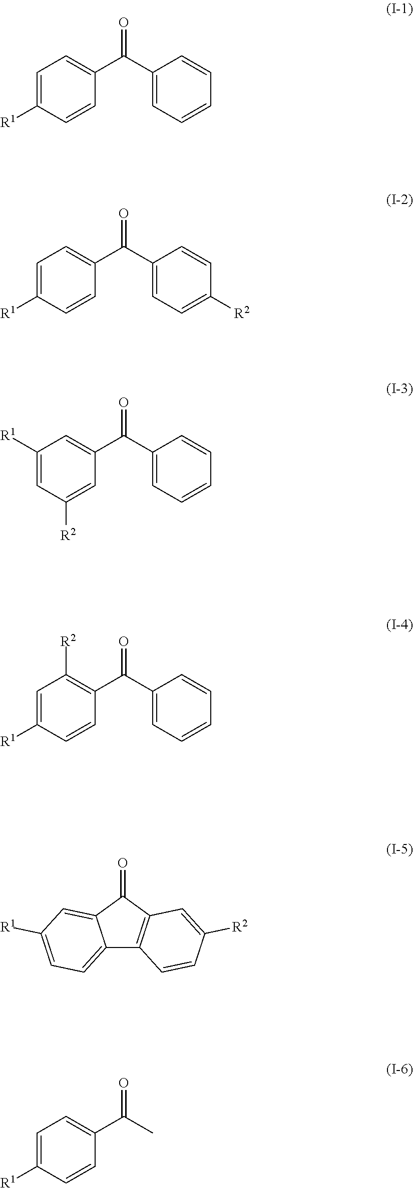

wherein R¹ and R² may be the same as or different from each other, and each represent a -Sp¹-P¹ group, hydrogen atom, halogen atom, —CN group, —NO₂ group, —NCO group, —NCS group, —OCN group, —SCN group, —SF₅ group, C1-C12 linear or branched alkyl or aralkyl group, phenyl group, or biphenyl group, at least one of R¹ and R² have a -Sp¹-P¹ group, P¹ represents an acryloyloxy, methacryloyloxy, vinyl, vinyloxy, acryloylamino, methacryloylamino group, Sp¹ represents a C1-C6 linear, branched, or cyclic alkylene or alkyleneoxy group or a direct bond, when R¹ and R² each represent a phenyl, biphenyl, or C1-C12 linear or branched alkyl or aralkyl group, a hydrogen atom on R¹ and R² may be replaced by a fluorine atom, chlorine atom, or -Sp¹-P¹ group, a —CH₂— group on R¹ and R² may be substituted with a —O—, —S—, —NH—, —CO—, —COO—, —OCO—, —O—COO—, —OCH₂—, —CH₂O—, —SCH₂—, —CH₂S—, —N(CH₃)—, —N(C₂H₅)—, —N(C₃H₇)—, —N(C₄H₉)—, —CF₂O—, —OCF₂—, —CF₂S—, —SCF₂—, —N(CF₃)—, —CH₂CH₂—, —CF₂CH₂—, —CH₂CF₂—, —CF₂CF₂—, —CH═CH—, —CF═CF—, —C≡C—, —CH═CH—COO—, or —OCO—CH═CH— group, provided that oxygen, sulfur, and nitrogen atoms are not adjacent to one another. This embodiment is referred to as Embodiment A in the following.

These monomers can absorb light of less than 400 nm but hardly absorbs light of 400 nm or more. Accordingly, when the liquid crystal display device has a back light unit, the light from the back light unit is hardly absorbed, leading to further improvement in the long-term reliability. The use of these monomers increases the polymerization rate effectively as compared with Comparative Embodiment 1.

The polymerizable monomer represented by Formula (I) may be a polymerizable monomer represented by any of Formulae (I-7) to (I-8) mentioned below;

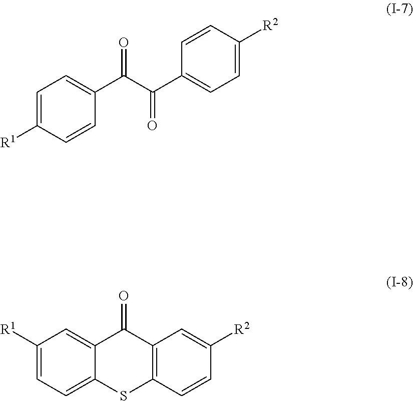

wherein R¹ and R² may be the same as or different from each other, and each represent a -Sp¹-P¹ group, hydrogen atom, halogen atom, —CN group, —NO₂ group, —NCO group, —NCS group, —OCN group, —SCN group, —SF₅ group, C1-C12 linear or branched alkyl or aralkyl group, phenyl group, or biphenyl group, at least one of R¹ and R² have a -Sp¹-P¹ group, P¹ represents an acryloyloxy, methacryloyloxy, vinyl, vinyloxy, acryloylamino, or methacryloylamino group, Sp¹ represents a C1-C6 linear, branched, or cyclic alkylene or alkyleneoxy group, or a direct bond, when R¹ and R² each represent a phenyl, biphenyl, or a C1-C12 linear or branched alkyl or aralkyl group, a hydrogen atom on R¹ and R² may be replaced by a fluorine atom, chlorine atom, or -Sp¹-P¹ group, a —CH₂— group on R¹ and R² may be substituted with a —O—, —S—, —NH—, —CO—, —COO—, —OCO—, —O—COO—, —OCH₂—, —CH₂O—, —SCH₂—, —CH₂S—, —N(CH₃)—, —N(C₂H₅)—, —N(C₃H₇)—, —N(C₄H₉)—, —CF₂O—, —OCF₂—, —CF₂S—, —SCF₂—, —N(CF₃)—, —CH₂CH₂—, —CF₂CH₂—, —CH₂CF₂—, —CF₂CF₂—, —CH═CH—, —CF═CF—, —C≡C—, —CH═CH—COO—, or —OCO—CH═CH— group, provided that oxygen, sulfur, and nitrogen atoms are not adjacent to one another. This embodiment is referred to as Embodiment B in the following.

These monomers can absorb light of less than 450 nm but hardly absorbs light of 450 nm or more. In other words, the monomers can absorb light of 400 nm or more. Accordingly, the photoabsorption efficiency of these monomers is higher than that of the monomers represented by Formulae (I-1) to (I-6). In Embodiment B, the polymerization rate is further increased compared to that in Embodiment A, resulting in improvement in the throughput. The photoalignment film used may be a common photoalignment film (e.g., one having a cinnamate group). The light absorbed by the common photoalignment film, however, has a wavelength of about 340-350 nm or shorter. The monomers represented by Formulae (I-7) to (I-8), therefore, can be polymerized with light of a wavelength not absorbed by the photoalignment film. As a result, the polymer layer can be formed without inducing a change in the initial alignment of liquid crystal molecules due to photoabsorption by the photoalignment film. Since light having a wavelength that is not absorbed by the photoalignment film can be used, it is possible to effectively suppress generation of impurities due to deterioration of the liquid crystal layer and the photoalignment film upon polymerization of monomers.

In Embodiments A and B, P¹ more preferably represents a methacryloyloxy group. This achieves a significantly high VHR. In addition, sufficient solubility of the monomers in a liquid crystal composition can be ensured.

In Embodiment A, A³ may represent a phenanthrene-2,7-diiyl, phenanthrene-3,6-diyl, phenanthrene-3,8-diyl, or phenanthrene-1,8-diyl group, P³ and P⁴ both may represent a methacryloxy group, and n may represent 0. Accordingly, the combination use of the monomer having a phenanthrene skeleton, among the monomers represented by Formula (II), and the monomer represented by any of Formulae (I-1) to (I-6) more effectively suppresses a change in the initial alignment of liquid crystal molecules, such as a change of the pretilt angle and disturbance of the initial alignment direction. Moreover, the residual DC voltage is more effectively reduced and occurrence of image sticking is more effectively suppressed. The use of a methacryloxy group more effectively ensures the long-term reliability.

In Embodiment B, A³ may represent a phenanthrene-2,7-diyl, phenanthrene-3,6-diyl, phenanthrene-3,8-diyl, or phenanthrene-1,8-diyl group, P³ and P⁴ both may represent a methacryloxy group, and n may represent 0. Thus, the combination use of a monomer having a phenanthrene skeleton, among the monomers represented by Formula (II), and the monomer represented by any of Formulae (I-7) to (I-8) more effectively suppresses a change in the initial alignment of liquid crystal molecules, for example, a change of the pretilt angle and disturbance of the direction of the initial alignment. Moreover, the residual DC voltage is more effectively reduced and occurrence of image sticking is more effectively suppressed. The use of a methacryloxy group more effectively ensures the long-term reliability.

In Embodiment A, A³ and A⁴ both may represent a 1,4-phenylene group, P³ and P⁴ both may represent a methacryloxy group, and n may represent 1. Thus, the combination use of a monomer having a phenylene group (especially, biphenyl group), among the monomers represented by Formula (II), and the monomer represented by any of Formulae (I-1) to (I-6) more effectively suppresses a change in the initial alignment of liquid crystal molecules, for example, a change of the pretilt angle and disturbance of the initial alignment direction. Moreover, the residual DC voltage is more effectively reduced and occurrence of image sticking is more effectively suppressed. The use of a methacryloxy group more effectively ensures the long-term reliability.

In Embodiment B, A³ and A⁴ both may represent a 1,4-phenylene group, P³ and P⁴ both may represent a methacryloxy group, and n may represent 1. Thus, the combination use of a monomer having a phenylene group (especially, biphenyl group), among the monomers represented by Formula (II), and the monomer represented by any of Formulae (I-7) to (I-8) more effectively suppresses a change in the initial alignment of liquid crystal molecules, for example, a change of the pretilt angle and disturbance of the initial alignment direction. Moreover, the residual DC voltage is more effectively reduced and occurrence of image sticking is more effectively suppressed. The use of a methacryloxy group more effectively ensures the long-term reliability.

The photoalignment film may contain a polymer having a main-chain structure of polyimide, polyamide, polyvinyl, polysiloxane, polymaleimide, or derivatives thereof. This enables the monomer represented by Formula (I) to easily abstract hydrogen in the main-chain structure of these polymers. Accordingly, the radical generation efficiency by hydrogen abstraction is effectively improved, so that polymerization of monomers and formation of a polymer layer are more efficiently conducted.

In the device according to the present invention, the photoalignment film may align liquid crystal molecules in the liquid crystal layer in a direction orthogonal to the surface of the alignment film when no voltage is applied to the liquid crystal layer. Here, the alignment in the orthogonal direction is not necessarily the alignment in a direction strictly at 90° relative to the surface. Quantitatively, the pretilt angle of the liquid crystal layer may be not less than 80° but not more than 90°.

In the device according to the present invention, the photoalignment film may align liquid crystal molecules in the liquid crystal layer in a direction parallel with the surface of the alignment film. Here, the alignment in the parallel direction is not necessarily the alignment in a direction strictly at 0° relative to the surface. Quantitatively, the pretilt angle of the liquid crystal layer may be not less than 0° but less than 10°.

In the device according to the present invention, the photoalignment film may align liquid crystal molecules in the liquid crystal layer in an oblique direction relative to the surface of the alignment film. Quantitatively, the pretilt angle of the liquid crystal layer may be not less than 10° but less than 80°.

the photoalignment film preferably contains at least one of a compound (preferably, a polymer) having at least one photoreactive functional group selected from the group consisting of cinnamate, chalcone, coumarin, azobenzene, tolan, and stilbene groups, and derivatives thereof. This enables the monomer represented by Formula (I) to easily abstract hydrogen in these photoreactive functional groups. Accordingly, the radical generation efficiency by hydrogen abstraction is effectively improved, so that polymerization of monomers and formation of a polymer layer are more efficiently conducted.

The device according to the present invention may further include a back light unit. As in Comparative Embodiment 1, in the case of using only a monomer that starts polymerization by photo-fries rearrangement, the VHR may be lowered after backlight aging, possibly causing image sticking. In contrast, in the device according to the present invention, lowering of the VHR after backlight aging is effectively suppressed.

Here, the term “backlight aging” refers to aging carried out while the back light unit is turned on.

One of the first and second substrates may have a color filter and a switching element. In such a case, the other substrate is commonly provided on the viewer side. Moreover, the other substrate commonly does not include a photoabsorbing resin such as a color filter and a UV-curable acrylic resin. Accordingly, the light emitted from the back light unit may reach the viewer side and pass through the other substrate, possibly reaching the liquid crystal layer. As mentioned above, however, in the device according to the present invention, lowering of the VHR due to light from the back light unit is effectively suppressed. The present embodiment is suitably employed for the device according to the present invention. As described above, the device according to the present invention may have a color-filter-on-array (COA) structure.

The step of forming a polymer layer preferably includes polymerization of the two or more kinds of polymerizable monomers by irradiation of the liquid crystal layer with light of 330 nm or more (preferably, UV light having at least one peak wavelength in a range from 330 to 380 nm). Most of the monomers (I) absorb UV light of 330 nm or more, and therefore, the radical generation efficiency can be improved.

The step of forming a polymer layer preferably includes polymerization of the two or more kinds of polymerizable monomers by irradiation of the liquid crystal layer with light of 360 nm or more. This enables to form the polymer layer without inducing a change in the initial alignment of liquid crystal molecules due to photoabsorption of the photoalignment layer. Moreover, it also enables to effectively suppress generation of impurities due to deterioration of the liquid crystal layer and the photoalignment film upon polymerization of monomers.

The step of forming a polymer layer may include polymerization of the two or more kinds of polymerizable monomers with application of a voltage of the threshold value or greater to the liquid crystal layer. This enables precise control of the tilt angle and/or alignment direction of the liquid crystal molecules.

The step of forming a polymer layer may include polymerization of the two or more kinds of polymerizable monomers with application of a voltage lower than the threshold value to the liquid crystal layer or without application of a voltage to the liquid crystal layer.

The threshold voltage as used herein refers to the voltage at which an electric field generates, thereby optically changing the liquid crystal layer and also changing the display state in the liquid crystal display device. For example, the voltage at which the transmittance becomes 5% is meant when the transmittance in the white display state is set to 100%.

The alignment treatment of the photoalignment film may be concurrently carried out with polymerization of polymerizable monomers in the step of forming a polymer layer (Case (1)) or carried out before formation of a liquid crystal layer (Case (2)). Preferably, the method according to the present invention further includes the step of performing alignment treatment on the photoalignment film by irradiating the photoalignment film with light before the step of forming a liquid crystal layer. The concurrent performance of the alignment treatment and polymerization of monomers reduces the number of production steps by one. On the other hand, the separate performance of the photoalignment treatment and polymerization of monomers enables direct irradiation of the photoalignment film with light, not through the substrate. In such a case, the alignment treatment can be performed with a small irradiation dose. Moreover, the alignment treatment (divided alignment treatment) for forming a multi-domain structure is easily performed.

One of the first and second substrates may be provided with no photoalignment film. Preferably, the first and second substrates each have a photoalignment film described above. In such a case, various settings such as materials and conditions for the alignment treatment may be appropriately determined for each layer. Commonly, these settings for both of the photoalignment films are the same. Alternatively, the photoalignment film on the first substrate may form a network structure through the liquid crystal layer so as to be formed not only on the first substrate but also on the second substrate.

### Advantageous Effects of Invention

The present invention provides a liquid crystal display device that can suppress image sticking, ensure the long-term reliability, and improve the display quality; and a method of producing the same.

### BRIEF DESCRIPTION OF DRAWINGS

FIGS. 1(a) to 1(e) are schematic perspective views for explaining the method of producing a liquid crystal display device according to Embodiment 1.

FIG. 2 is a schematic cross-sectional view of a liquid crystal panel (of the horizontal alignment type) included in the liquid crystal display device according to Embodiment 1, and shows a state before polymerization.

FIG. 3 is a schematic cross-sectional view of a liquid crystal panel (of the vertical alignment type) included in the liquid crystal display device according to Embodiment 1, and shows a state before polymerization.

FIG. 4 is a schematic cross-sectional view of a liquid crystal panel (of the spray alignment type) included in the liquid crystal display device according to Embodiment 1, and shows a state before polymerization.

FIG. 5 is a schematic cross-sectional view of a liquid crystal panel (of the horizontal alignment type) included in the liquid crystal display device according to Embodiment 1, and shows the state after polymerization.

FIG. 6 is a schematic cross-sectional view of a liquid crystal panel (of the vertical alignment type) included in the liquid crystal display device according to Embodiment 1, and shows a state after polymerization.

FIG. 7 is a schematic cross-sectional view of a liquid crystal panel (of the spray alignment type) included in the liquid crystal display device according to Embodiment 1, and shows a state after polymerization.

FIG. 8 is a schematic cross-sectional view of the liquid crystal display device according to Embodiment 1.

FIG. 9 is a schematic cross-sectional view of the liquid crystal display device according to Embodiment 1.

FIG. 10 is an absorption spectrum of a polymerizable monomer represented by Formula (1).

FIG. 11 shows an emission spectrum of an irradiation device used in the polymerization step of evaluation tests.

FIG. 12 shows an absorption spectrum of a polymerizable monomer represented by Formula (7).

FIGS. 13(a) to 13(e) are schematic perspective views for explaining a liquid crystal display device according to Comparative Embodiment 1.

### DESCRIPTION OF EMBODIMENTS

The present invention is more specifically described based on embodiments with reference to drawings. The present invention is not limited only to these embodiments.

The liquid crystal mode of the liquid crystal display device according to the present invention is not particularly limited, and examples thereof include IPS (In-Plane Switching), FFS (Fringe Field Switching), TN (Twisted Nematic), OCB (Optically Compensated Birefringence), STN (Super Twisted Nematic), VA (Vertical Alignment), VA-TN (Vertical Alignment—Twisted Nematic), and TBA (Transverse Bend Alignment) modes.

The voltage application system in the liquid crystal display device according to the present invention is not particularly limited, and examples thereof include the vertical field system, transverse field system, and oblique field system.

In the following, a description is given on an active matrix-driving liquid crystal display device. The driving system of the liquid crystal display device according to the present invention is not particularly limited, and may be, for example, a passive driving system.

### Embodiment 1

In the present embodiment, at least two kinds of polymerizable monomers are used, which include a monomer that increases the polymerization rate as compared with a conventional case and a monomer that improves the residual DC voltage and prevents lowering of the VHR. Conventionally, as shown in Reaction Formula (a), polymerization is initiated by generation of radicals by photo-fries rearrangement. However, the radical generation efficiency by the photo-fries rearrangement is low, so that the polymerization rate was insufficient. In the present embodiment, in order to increase the polymerization rate, the used monomer has a hydrogen-abstraction structure as shown in Reaction Formula (b) mentioned below and generates radicals such as ketyl radicals by hydrogen abstraction. In other words, the monomer used to achieve a faster polymerization rate than that in a conventional case is a monomer that generates radicals by hydrogen abstraction. The hydrogen-abstraction structure refers to a chemical structure that causes a hydrogen abstraction reaction as shown in Reaction Formula (b), for example. Specific examples thereof include a benzophenone skeleton and a benzyl skeleton.

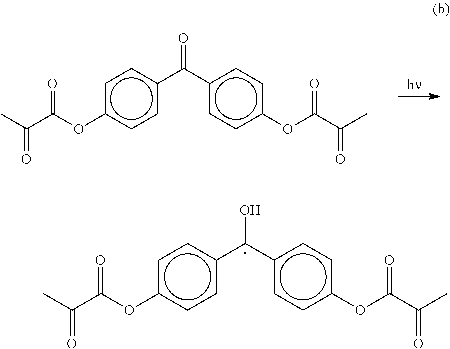

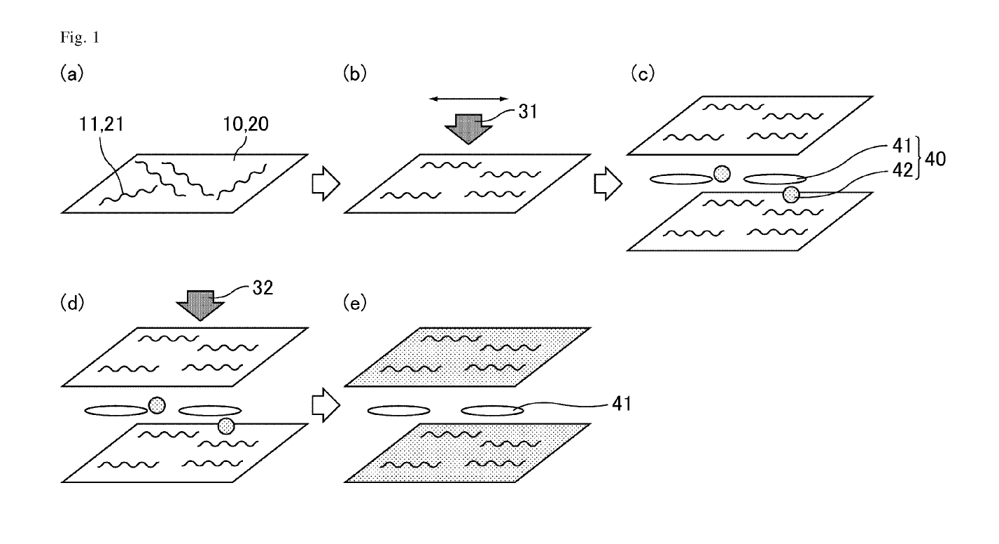

With reference to FIGS. 1 to 9, a description is given on a method of producing a liquid crystal display device according to Embodiment 1.

First, a pair of substrates 10 and 20 are provided. One of the substrates 10 and 20 corresponds to the first substrate, and the other corresponds to the second substrate. The substrates 10 and 20 each have plural pixel regions, and each pixel region include plural sub-pixel regions. The substrate is an array substrate and includes an insulating substrate made of glass, resin, or the like; wiring such as gate bus lines, source bus lines, and capacitance wiring; electrodes such as pixel electrodes; switching elements such as thin film transistors (TFT); and insulating layers such as a gate insulator and an interlayer insulating film. The substrate 10 may include various drivers such as a gate driver and a source driver. The substrate 20 is a color filter substrate and includes color filters of plural colors and a black matrix (BM) The substrate 20 may further have a spacer (e.g., a columnar spacer). Alternatively, the substrate 20 may only include an insulating substrate.

Each pixel electrode is provided in the sub-pixel region. At least one of the substrates 10 and 20 has a common electrode facing the pixel electrode. Voltage application to these electrodes enables to electrically control the alignment of liquid crystal molecules in each pixel. The color filter is provided in correspondence to the sub-pixel region, and the displayed color is controlled in each pixel.

The layout of the pixel electrode and common electrode can be appropriately determined. In the case of the transverse field system, the pixel electrode and common electrode may be a pair of comb electrodes. Alternatively, one electrode may have a shape with slits and the other electrode may have a shape without slits (e.g., rectangular shape). In the case of the vertical field system, the pixel electrode and common electrode may have a shape without slits (e.g., rectangular shape). Alternatively, the pixel electrode may have a fish-bone shape. The pixel electrode and common electrode may be transparent or opaque. Commonly, they are transparent. In the case of transparent electrodes, the material of the pixel electrode and common electrode may be a transparent conductive material (e.g., ITO).

Next, the step of forming an alignment film is conducted.

A composition for forming an alignment film containing a material of an alignment film and a solvent (e.g., organic solvent) is provided. The composition for forming an alignment film is applied to the surface of both of the substrates 10 and 20 by a method such as ink-jet printing, spin coating, or flexo printing. Next, the composition for forming an alignment film is dried. Thus, the solvent in the composition is volatilized. As a result, as shown in FIG. 1(a), photoalignment films 11 and 21 are formed on the substrates 10 and 20, respectively. It is to be noted that only one of the photoalignment films 11 and 21 may be formed.

The material of an alignment film is not particularly limited, provided that it is active against light. Examples thereof include materials used for conventional photoalignment films. Preferably, the material contains a polymer having a main-chain structure of polyimide, polyamide, polyvinyl, polysiloxane, polymaleimide, or derivatives thereof. This enables the monomer represented by Formula (I) described later to easily abstract hydrogen in the main-chain structure of the polymer. Accordingly, the radical generation efficiency by hydrogen abstraction is effectively improved, so that polymerization of monomers and formation of a polymer layer are more efficiently conducted.

Commonly, the material selected for forming the alignment film causes a reaction such as photolysis, photoisomerization, and photodimerization. The photoisomerization and photodimerization are commonly initiated by a smaller irradiation dose of light of a longer wavelength than the photolysis. Accordingly, from the standpoint of improving the mass productivity, the material preferably causes photoisomerization and/or photodimerization

The material of the alignment film preferably contains a functional group that is active against light (preferably, UV light). More specifically, the material preferably contains a compound (preferably, polymer) having a photoreactive functional group selected from the group consisting of cinnamate, chalcone, coumarin, azobenzene, tolan, and stilbene groups and/or derivatives thereof. This enables the monomer represented by Formula (I) described later to easily abstract hydrogen from the photoreactive functional group. Accordingly, the radical generation efficiency by hydrogen abstraction is effectively improved, so that polymerization of monomers and formation of a polymer layer are more efficiently conducted. It is to be noted that the above reaction, especially, photoisomerization and/or photodimerization is caused in the functional group. The functional group is commonly included in the side chain of a polymer. Moreover, the benzene ring in the functional group may be a heterocycle.

The material of the alignment film may include one or two or more kinds of materials. For example, the material may include one or two or more kinds of polymer materials, or include at least one polymer material and at least one low-molecular material (e.g., an additive).

The drying step may be divided into plural stages. For example, the drying step may include pre-baking and post-baking. The time and temperature for drying may be determined as appropriate.

Next, the step of photoalignment treatment is conducted, in which the alignment treatment (photoalignment treatment) is performed on the photoalignment films 11 and 21. Specifically, as shown in FIG. 1(b), the photoalignment films 11 and 21 are each irradiated with light 31. As a result, at least part of the photoalignment films 11 and 21 (preferably, photoreactive functional groups) have the reaction described above therein, so as to have its molecular structure and/or alignment changed. The resulting photoalignment films 11 and 21 can control the alignment of liquid crystal molecules that are in contact with the surface thereof. In other words, the photoalignment treatment provides the photoalignment films 11 and 21 with properties of controlling the alignment of liquid crystal molecules, so that the photoalignment film 11 and 21 each serve as the alignment film. Commonly, not the whole of the photoalignment films 11 and 21 (preferably, photoreactive functional groups) have the reaction described above. Accordingly, the photoreactive functional groups are partly present even after the alignment treatment.

As described above, the photoalignment technique enables alignment treatment of the alignment film by irradiation of an alignment film formed of a photoreactive material with light (e.g., UV light). According to the photoalignment technique, the alignment film does not require rubbing treatment, which means the alignment treatment can be performed without any contact to the alignment film. As a result, contamination and dust can be suppressed during the alignment treatment. Such a technique can be more appropriately employed for a large-sized panel than the rubbing treatment.

The wavelength of the light 31 to be used for irradiation of the photoalignment films 11 and 21 can be appropriately determined. The light 31 preferably includes UV light. More preferably, the light 31 is UV light. More specifically, the light 31 may be a light of a wavelength within a range from 265 to 350 nm. The light 31 may be polarized light (linearly polarized light, elliptically polarized light, or circularly polarized light) or non-polarized light. For example, the light 31 may be polarized UV light having a polarization axis in a direction of the bidirectional arrow in FIG. 1(b). The lighting direction of the light 31 is not particularly limited, and may be oblique (e.g., a direction at 00 to 700 relative to the normal direction of the principal plane) or orthogonal to the principal plane of the substrates 10 and 20. The irradiation dose of the light 31 may be appropriately determined, and may be, for example, 1 to 200 mJ/cm² at 360 nm.

By appropriately setting the wavelength of light used for irradiation, irradiation time and intensity, and materials of the alignment film, the pretilt angle and initial alignment direction can be controlled.

At least one of the photoalignment films 11 and 21 may have plural regions with different controllability of the alignment in each sub-pixel region. In this case, for example, part of the photoalignment film 11 is masked, a predetermined region of the photoalignment film 11 is first irradiated with light in a certain direction, and the region not yet irradiated with light (region masked during the first irradiation) is second irradiated with light in a different direction. The photoalignment film 21 is also subjected to similar treatment. Thus, the plural regions are formed in the photoalignment films 11 and 21.

It is to be noted that the alignment treatment of the photoalignment films 11 and 21 may be performed in the polymerization step described later. In the case of performing the alignment treatment and polymerization of monomers separately, the photoalignment films 11 and 21 can be directly irradiated with light, not through the substrates 10 and 20. In such a case, the alignment treatment can be performed with a small irradiation dose. Moreover, the alignment treatment (divided alignment treatment) for forming a multi-domain structure is easily performed.

Next, the step of forming a liquid crystal panel is conducted.

First, prepared is a liquid crystal composition containing at least one kind of liquid crystal molecules 41 and two or more kinds of polymerizable monomers 42. Next, as shown in FIGS. 1(c) and 2 to 4, a liquid crystal layer 40 containing the liquid crystal molecules 41 and the polymerizable monomers 42 is formed between the substrates 10 and 20 by vacuum injection or drop injection.

In the case of vacuum injection, application of a sealing material, bonding of the substrates, curing of the sealing material, injection of the liquid crystal composition, and sealing of the inlet are performed in the stated order.

In the case of drop injection, application of a sealing material, dropping of the liquid crystal composition, bonding of the substrates, and curing of the sealing material are performed in the stated order.

The kind and number of the liquid crystal molecules 41 are not particularly limited. Commonly, the liquid crystal molecules 41 include thermotropic liquid crystals, preferably liquid crystal molecules exhibiting a nematic phase (nematic liquid crystals). Thus, the liquid crystal layer 40 exhibits a nematic phase. The liquid crystal molecules 41 may have a positive dielectric anisotropy (positive type) or negative dielectric anisotropy (negative type). For the purpose of securing the reliability and improving the response time, the liquid crystal molecules 41 may include two or more kinds of liquid crystal molecules. The use of two or more kinds of liquid crystal molecules enables to adjust as desired the physical properties of the liquid crystals such as nematic phase-isotropic phase transition temperature Tni, elastic constant k, dielectric anisotropy Δ∈, and refractive index anisotropy Δn.

The monomer 42 contains at least one kind of polymerizable monomer represented by Formula (I) (hereafter, also referred to as a monomer (I)) and at least one kind of polymerizable monomer represented by Formula (II) (hereafter, also referred to as a monomer (II)).

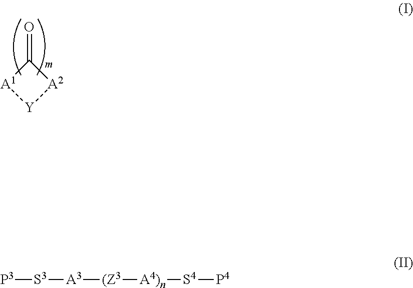

A description is given on a monomer (I) in the following. A¹ and A² may be the same as or different from each other, and each represent a benzene ring, biphenyl ring, or a C1-C12 linear or branched alkyl or alkenyl group. One of A¹ and A² represents a benzene or biphenyl ring. In other words, one of A¹ and A² represents a benzene or biphenyl ring, and the other represent a benzene ring, biphenyl ring, or a C1-C12 linear or branched alkyl or alkenyl group. At least one of A¹ and A² contains a -Sp¹-P¹ group.

A hydrogen atom on A¹ and A² may be replaced by a -Sp¹-P¹ group, halogen atom, —CN group, —NO₂ group, —NCO group, —NCS group, —OCN group, —SCN group, —SF₅ group, or a C1-C12 linear or branched alkyl, alkenyl, or aralkyl group.

Two hydrogen atoms bonded to two adjacent carbons on A¹ and A² may be replaced by a C1-C12 linear or branched alkylene or alkenylene group to form a ring structure.

A hydrogen atom on the alkyl, alkenyl, alkenylene, or aralkyl group in A¹ and A² may be replaced by a -Sp¹-P¹ group.

A —CH₂— group on the alkyl, alkenyl, alkylene, alkenylene, or aralkyl group in A¹ and A² may be substituted with a —O—, —S—, —NH—, —CO—, —COO—, —OCO—, —O—COO—, —OCH₂—, —CH₂O—, —SCH₂—, —CH₂S—, —N(CH₃)—, —N(C₂H₅)—, —N(C3H)—, —N(C₄H₉)—, —CF₂O—, —OCF₂—, —CF₂S—, —SCF₂—, —N(CF₃)—, —CH₂CH₂—, —CH₂CF₂—, —CF₂CH₂—, —CF₂CF₂—, —CH═CH—, —CF═CF—, —C≡C—, —CH═CH—COO—, or —OCO—CH═CH— group, provided that oxygen, sulfur, and nitrogen atoms are not adjacent to one another.

P¹ represents a polymerizable group.

Sp¹ represents a C1-C6 linear, branched, or cyclic alkylene or alkyleneoxy group or a direct bond.

m represents 1 or 2.

A dotted line between A¹ and Y and a dotted line between A² and Y represent an optional bond between A¹ and A² via Y.

Y represents a —CH₂—, —CH₂CH₂—, —CH═CH—, —O—, —S—, —NH—, —N(CH₃)—, —N(C₂H₅)—, —N(C₃H₇)—, —N(C₄H₉)—, —OCH₂—, —CH₂O—, —SCH₂—, or —CH₂S— group or a direct bond.

A description is given on a monomer (II) in the following.

P³ and P⁴ may be the same as or different from each other, and each represent an acryloyloxy, methacryloyloxy, acryloylamino, methacryloylamino, vinyl, or vinyloxy group.

A³ and A⁴ may be the same as or different from each other, and each represent a 1,4-phenylene, 4,4′-biphenyl, naphthalene-2,6-diyl, phenanthrene-2,7-diyl, phenanthrene-3,6-diyl, phenanthrene-3,8-diyl, or phenanthrene-1,8-diyl group.

Z³ may be the same as or different from each other, and each represent a —COO—, —OCO—, —O—, —CO—, —NHCO—, —CONH—, or —S— group or a direct bond between A³ and A⁴ or between A⁴ and A⁴.

n represents 0, 1, 2, or 3.

S³ and S⁴ may be the same as or different from each other, and each represent a —(CH₂)ₘ— group (m representing a natural number satisfying 1≦m≦6), —(CH₂—CH₂—O)ₘ— group (m representing a natural number satisfying 1≦m≦6), or direct bond between P³ and A³, between A³ and P⁴, or between A⁴ and P⁴.

A hydrogen atom on A³ and A⁴ may be replaced by a halogen or methyl group.

Preferable examples of the monomer (I) include polymerizable monomers represented by Formulae (I-1) to (I-6) (hereafter, also referred to as monomers (I-1) to (I-6)). The monomers (I-1) to (I-6) can absorb light of less than 400 nm but hardly absorbs light of 400 nm or more. Accordingly, in a case where the liquid crystal display device of the present embodiment has a back light unit, the monomers hardly absorb light from the back light unit, leading to further improvement of the long-term reliability. Moreover, the use of these monomers effectively increases the polymerization rate as compared with Comparative Embodiment 1.

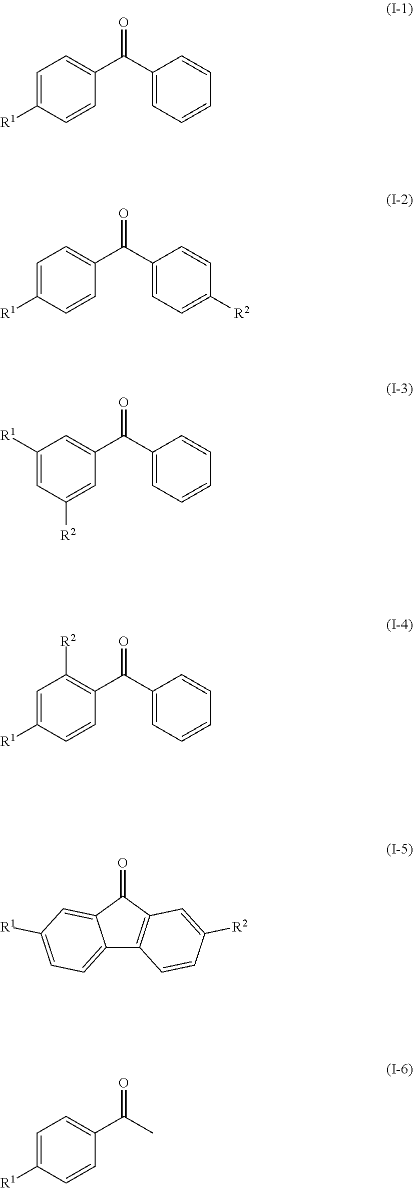

Other preferable examples of the monomer (I) include polymerizable monomers represented by Formulae (I-7) and (I-8) (hereafter, also referred to as monomers (I-7) and (I-8)). The monomers (I-7) and (I-8) absorb light of less than 450 nm, but hardly absorb light of 450 nm or more. In other words, the monomers (I-7) and (I-8) can absorb light of 400 nm or more. Accordingly, the photoabsorption efficiency of these monomers is higher than that of the monomers (I-1) to (I-6). In the case of using the monomers (I-7) and (I-8), the polymerization rate is further increased compared to the case of using the monomers (I-1) to (I-6), resulting in improvement in the throughput. Conventional photoalignment films (e.g., films having a cinnamete group) may be used as the photoalignment films 11 and 21. The light absorbed by the conventional photoalignment films, however, has a wavelength in of about 340-350 nm or shorter. The monomers (I-7) and (I-8), therefore, can be polymerized with light of a wavelength not absorbed by the photoalignment films 11 and 21. As a result, the polymer layer can be formed without inducing a change in the initial alignment of the liquid crystal molecules 41 due to photoabsorption by the photoalignment films 11 and 21. Since light having a wavelength that is not absorbed by the photoalignment films 11 and 21 can be used, it is possible to effectively suppress generation of impurities due to deterioration of the liquid crystal layer 40 and the photoalignment films 11 and 21 upon polymerization of monomers.

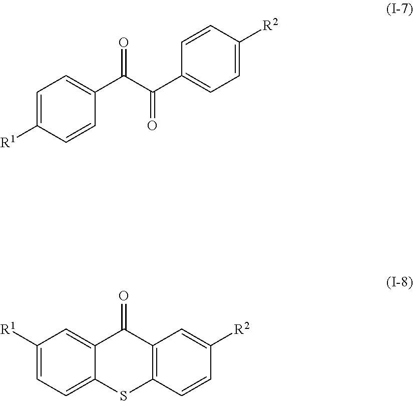

A description is given on the monomers (I-1) to (I-6) and the monomers (I-7) and (I-8) in the following.

R¹ and R² may be the same as or different from each other, and each represent a -Sp¹-P¹ group, hydrogen atom, halogen atom, —CN group, —NO₂ group, —NCO group, —NCS group, —OCN group, —SCN group, —SF₅ group, C1-C12 linear or branched alkyl or aralkyl group, phenyl group, or biphenyl group.

At least one of R¹ and R² contains a -Sp¹-P¹ group.

P¹ represents a polymerizable group, especially an acryloyloxy group, methacryloyloxy group, vinyl group, vinyloxy group, acryloylamino group, or methacryloylamino group.

Sp¹ represents a C1-C6 linear, branched, or cyclic alkylene or alkyleneoxy group, or direct bond.

When R¹ and R² each represent a C1-C12 linear or branched alkyl or aralkyl group, phenyl group, or biphenyl group, a hydrogen atom on R¹ and R² may be replaced by a fluorine atom, chlorine atom, or -Sp¹-P¹ group.

A —CH₂— group on R¹ and R² may be substituted with a —O—, —S—, —NH—, —CO—, —COO—, —OCO—, —O—COO—, —OCH₂—, —CH₂O—, —SCH₂—, —CH₂S—, —N(CH₃)—, —N(C₂H₅)—, —N(C₃H₇)—, —N(C₄H₉)—, —CF₂O—, —OCF₂—, —CF₂S—, —SCF₂—, —N(CF₃)—, —CH₂CH₂—, —CF₂CH₂—, —CH₂CF₂—, —CF₂CF₂—, —CH═CH—, —CF═CF—, —C≡C—, —CH═CH—COO—, or —OCO—CH═CH— group, provided that oxygen, sulfur, and nitrogen atoms are not adjacent to one another.

Preferably, in the monomer (I), monomers (I-1) to (I-6), and monomers (I-7) and (I-8), specific examples of P¹ include a methacryloyloxy group. A methacryloyloxy group is especially favorable in the case of using the monomers (I-1) to (I-6) and monomers (I-7) and (I-8). The use of a methacryloyloxy group achieves significantly high VHR. In addition, sufficient solubility of the monomers (I) and (I-1) to (I-8) in a liquid crystal composition can be ensured.

In the monomer (II), A³ may represent a phenanthrene-2,7-diyl, phenanthrene-3,6-diyl, phenanthrene-3,8-diyl, or phenanthrene-1,8-diyl group, P³ and P⁴ each may represent a methacryloxy group, and n may represent 0.

In the case of using any of the monomers (I-1) to (I-6), in the monomer (II), preferably, A³ represents a phenanthrene-2,7-diyl, phenanthrene-3,6-diyl, phenanthrene-3,8-diyl, or phenanthrene-1,8-diyl group, both P³ and P⁴ represent a methacryloxy group, and n represents 0. This enables more effective suppression of the change in the initial alignment of the liquid crystal molecules 41, such as a change of the pretilt angle and disturbance of the initial alignment direction. In addition, the residual DC voltage is more effectively reduced and occurrence of image sticking is more effectively suppressed. The use of a methacryloxy group more effectively secures the long-term reliability.

Moreover, also in the case of using any of the monomers (I-7) and (I-8), in the monomer (II), preferably, A³ represents a phenanthrene-2,7-diyl, phenanthrene-3,6-diyl, phenanthrene-3,8-diyl, or phenanthrene-1,8-diyl group, both P³ and P⁴ represent a methacryloxy group, and n represents 0. This enables more effective suppression of the change in the initial alignment of the liquid crystal molecules 41, such as a change of the pretilt angle and disturbance of the initial alignment direction. In addition, the residual DC voltage is more effectively reduced and occurrence of image sticking is more effectively suppressed. The use of a methacryloxy group more effectively ensures the long-term reliability.

In the monomer (II), both A³ and A⁴ may represent a 1,4-phenylene group, both P³ and P⁴ may represent a methacryloxy group, and n may represent 1.

In the case of using any of the monomers (I-1) to (I-6), in the monomer (II), preferably, both A³ and A⁴ represent a 1,4-phenylene group, both P³ and P⁴ represent a methacryloxy group, and n represents 1. This enables more effective suppression of the change in the initial alignment of the liquid crystal molecules 41, such as a change of the pretilt angle and disturbance of the initial alignment direction. In addition, the residual DC voltage is more effectively reduced and occurrence of image sticking is more effectively suppressed. The use of a methacryloxy group more effectively ensures the long-term reliability.

In the case of using the monomers (I-7) and (I-8), in the monomer (II), both A³ and A⁴ may represent a 1,4-phenylene group, both P³ and P⁴ may represent a methacryloxy group, and n may represent 1. This enables more effective suppression of the change in the initial alignment of the liquid crystal molecules 41, such as a change of the pretilt angle and disturbance of the initial alignment direction. In addition, the residual DC voltage is more effectively reduced and occurrence of image sticking is more effectively suppressed. The use of a methacryloxy group more effectively ensures the long-term reliability.

The number of kinds of the monomer 42 is not particularly limited, provided that it includes at least one kind of monomer (I) and at least one kind of monomer (II). The monomer 42 may include two or more kinds of the monomers (I) or two or more kinds of the monomers (II). Alternatively, the monomer 42 may include only one monomer (I) and only one monomer (II).

The concentration of the monomer (I) in the whole liquid crystal composition is preferably not less than 0.01% by weight but less than 0.2% by weight. If the concentration of the monomer (I) is 0.2% by weight or more, the monomer (I) may be slightly left in the liquid crystal layer 40, resulting in the reduction of the effect of suppressing image sticking and/or lowering of the long-term reliability. If the concentration of the monomer (I) is less than 0.01% by weight, the effect of initiating polymerization may be too small. In other words, the possibility of generating a radical by abstracting hydrogen from the monomer (I) excited by photoabsorption may be too small. The concentration of the monomer (II) in the whole liquid crystal composition is preferably not less than 0.15% by weight but less than 3.0% by weight. If the concentration of the monomer (II) is 3.0% by weight or more, the monomer (II) may fail to be completely dissolved in the liquid crystal composition. If the concentration of the monomer (II) is less than 0.15% by weight, since the concentration of the monomer (II) is low, the residual DC voltage may be increased and/or the VHR may be reduced. In other words, the effect of the monomer (II) may not be sufficiently exerted. The total concentration of the monomers (I) and (II) in the whole liquid crystal composition is preferably less than 3.0% by weight. If the total concentration is 3.0% by weight or more, the monomers (I) and (II) may fail to be completely dissolved in the liquid crystal composition.

Commonly, in a case where the concentration of the monomer (II) in the whole liquid crystal composition is less than 1.0% by weight, a network of a polymer layer described later may not be formed in the liquid crystal layer 40. In a case where the concentration of the monomer (II) in the whole liquid crystal composition is 1.0% by weight or more, the network may be formed. Similarly, in a case where the total concentration of the monomers (I) and (II) in the whole liquid crystal composition is less than 1.0% by weight, a network of a polymer layer is commonly not formed in the liquid crystal layer 40. In contrast, in a case where the total concentration is 1.0% by weight or more, the network may be formed.

The monomer 42 can be synthesized in the same way as in synthesis of a polymerizable monomer used in the conventional PSA technique. The liquid crystal layer 40 may optionally contain a chiral agent.

Next, the annealing step is conducted. For example, the liquid crystal layer 40 is heated at 60° C. to 150° C. for 5 to 80 minutes, and then cooled by blowing air to a liquid crystal panel. Thus, the flow alignment of the liquid crystal molecules 41 is removed, so that the liquid crystal molecules 41 are regularly aligned in accordance with the molecular structure of the photoalignment films 11 and 21. Accordingly, the liquid crystal layer 40 shows the desired alignment state.

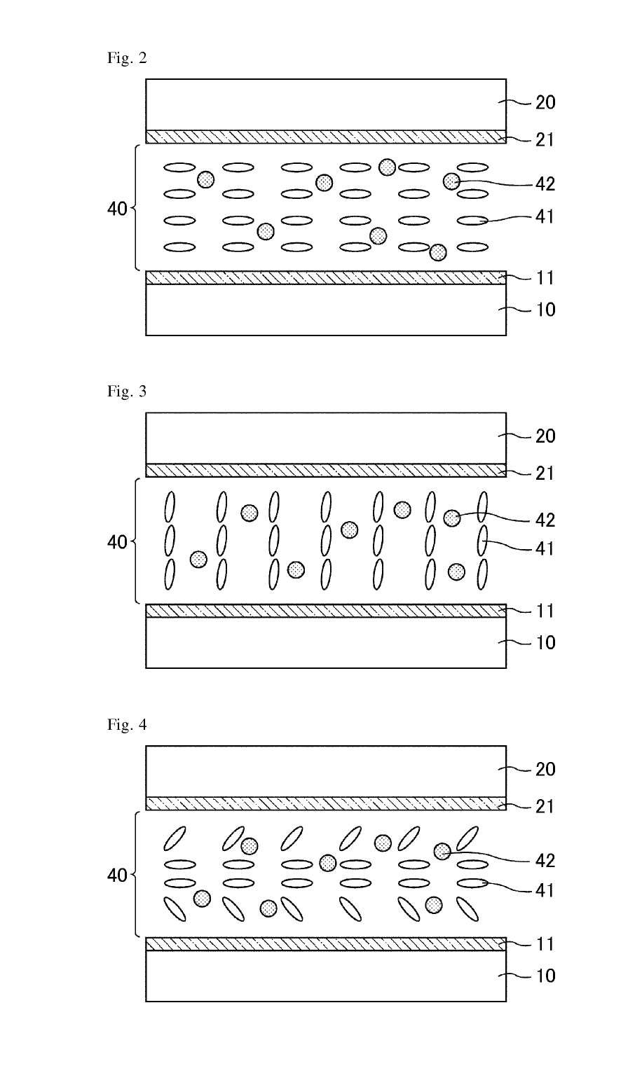

The alignment of the liquid crystal layer 40 is not particularly limited, and examples thereof include the twist alignment, hybrid alignment, homeotropic alignment (vertical alignment), homogeneous alignment (horizontal alignment), bend alignment, and spray alignment. As mentioned above, the photoalignment films 11 and 21 may be vertical alignment films. As shown in FIG. 3, the liquid crystal molecules 41 may be regularly tilt in a direction orthogonal to the surface of the alignment film under application of no voltage. Alternatively, the photoalignment films 11 and 21 may be horizontal alignment films. As shown in FIGS. 1(c) and 2, the liquid crystal molecules 41 may be regularly tilt in a direction in parallel with the surface of the alignment film under application of no voltage. Moreover, in the photoalignment films 11 and 21, as shown in FIG. 4, the liquid crystal molecules 41 may be regularly tilt in a direction oblique to the surfaces of the alignment films under application of no voltage.

Next, the polymerization step is conducted.

Specifically, as shown in FIG. 1(d), the liquid crystal layer 40 is irradiated with the light 32 from the outside of the liquid crystal panel. In this treatment, as shown in Reaction Formula (b), the monomer (I) causes hydrogen abstraction to generate a radical such as ketyl radicals. Then, the radical serves as a starting point of a polymerization reaction. As a result, as shown in FIGS. 1(e) and 5 to 7, layers (polymer layers) 12 and 22 containing a polymer having two or more kinds of monomer units derived from two or more kinds of the monomers 42 are formed on the photoalignment films 11 and 21, respectively. Formation of the polymer layers 12 and 22 enables to more stably keep the alignment of the liquid crystal molecules 41, compared to the case where only the photoalignment films 11 and 21 are provided.

Commonly, a radical generated by the photo-fries rearrangement is poor in stability and has a very short life. In contrast, a radical (e.g., a ketyl radical) generated by hydrogen abstraction is commonly more stable and has a longer life than a radical generated by the photo-fries rearrangement. Accordingly, the radical generation efficiency of the monomer (I) is higher than that of a monomer generating a radical by the photo-fries rearrangement. For this reason, in the present embodiment, compared to the case of using only the monomer (II), the polymerization rate is higher and a high reaction rate can be achieved even with a small irradiation dose. Especially, the combination use of the monomer (I) and a phenanthrene polymerizable monomer, as a monomer (II), may achieve the reaction rate twice as fast as that in the case of using only the monomer (II). Accordingly, in the present embodiment, the photoalignment films 11 and 21 are prevented from reacting to the light 32 for polymerization of monomers. This suppresses the change of the pretilt angle and disturbance of the initial alignment direction.

The use of not only the monomer (I) but also the monomer (II) enables to suppress an increase of the residual DC voltage and reduction of the VHR. If the liquid crystal layer 40 contains only the monomer (I) at a high concentration (e.g., 0.2% by weight or more), the polymerization reaction may not be completely carried out, and the monomer (I) and a radical (e.g., ketyl radical) produced from the monomer (I) may be slightly (e.g., minimum detectable quantity or less) left in the liquid crystal layer 40. In such a case, the radical generated from the monomer (I), which is highly stable as mentioned above, remains present in the liquid crystal layer 40, so that the residual DC voltage and VHR cannot be improved. Examples of the monomer (I) include a monomer absorbing light of about 370 nm or less (e.g., monomer (1) described later) and a monomer absorbing light of about 420 nm or less (e.g., monomer (7) described later). Accordingly, if a slightest amount of the monomer (I) is left in the liquid crystal layer 40, a radical is generated by light from the back light unit, leading to deterioration of the residual DC voltage and VHR.

To solve the problem, the monomer (I) and the monomer (II) are used in combination in the present embodiment. This enables to reduce the amount of the monomer (I) relative to the total amount of monomers needed for formation of the polymer layers 12 and 22. In other words, while the concentration of the monomer (I) is kept comparatively low (e.g., 0.05% by weight or less), the concentration of the entire monomer 42 is over a certain concentration (e.g., 0.15% by weight) by adding the monomer (II) that produces radicals with low stability, to the liquid crystal layer 40. This enables to effectively prevent radicals derived from the monomer (I) from remaining in the liquid crystal layer 40, so that the residual DC voltage and VHR can be improved. In addition, deterioration of the residual DC voltage and VHR after backlight aging is effectively suppressed.

As mentioned above, in the present embodiment, it is possible to suppress image sticking, ensure the long-term reliability, and improve the display quality.

The monomer (I) serves not only as a monomer forming a polymer but also as a polymerization initiator, and therefore, a polymerization initiator needs not to be added to the liquid crystal layer 40. This prevents deterioration of the display quality caused by a residual unreacted polymerization initiator. Moreover, no addition of a polymerization initiator is preferable in terms of suppressing image sticking.

The object from which hydrogen is abstracted by the monomer (I) is not particularly limited. Commonly, the monomer (I) presumably abstracts hydrogen from the photoalignment films 11 and 21 and not from the liquid crystal molecules 41. Accordingly, the radical derived from the monomer (I) is presumably likely to be generated in the vicinity of the surfaces of the photoalignment films 11 and 12. The polymer layers 12 and 22 are therefore preferentially formed on the photoalignment films 11 and 21, respectively.

In the polymerization step, the wavelength of the light 32 applied to the liquid crystal layer 40 is not particularly limited. The light 32 preferably includes UV light, and is more preferably UV light. Particularly preferably, the light 32 is a light of 330 nm or more (e.g., UV light having at least one peak wavelength in a range from 330 to 380 nm). The reason for this is that most of the monomers (I) absorb UV light of 330 nm or more. The monomer (II) may absorb light of about 315 nm or less. Alternatively, the light 32 may be light of 360 nm or more (including UV light). Accordingly, the polymer layers 12 and 22 can be formed without inducing the change in the initial alignment of the liquid crystal molecules 41 due to photoabsorption of the photoalignment films 11 and 21. Moreover, it is possible to effectively suppress generation of impurities due to deterioration of the liquid crystal layer 40 and the photoalignment films 11 and 21 during polymerization of monomers. The light 32 may be polarized light (linearly polarized light, elliptically polarized light, or circularly polarized light). Commonly, the light 32 is non-polarized light. The direction of the light 32 is not particularly limited, and may be a direction oblique to the principle surface of the substrates 10 and 20 (e.g., direction at 0° to 70° relative to the normal direction of the principle surface) or a direction orthogonal to the principle surface.

In the polymerization step, the alignment treatment of the photoalignment films 11 and 21 may be conducted concurrently with polymerization of monomers. In such a case, the light 32 is preferably applied in a direction oblique to the principle surfaces of the substrates 10 and 20. Concurrent performance of the alignment treatment and polymerization of monomers reduces the number of the production steps by one.

The irradiation dose of the light 32 may be appropriately determined, and is preferably not less than 20 mJ/cm² but less than 200 mJ/cm² at 360 nm. This enables 100% of the monomer 42 to be reacted.

Moreover, polymerization conditions such as the time and temperature of the reaction and application of the voltage can be appropriately determined. For example, the polymerization conditions employed in the conventional PSA technique may be employed. In Case (1), the monomer 42 may be polymerized under application of a voltage not less than the threshold voltage to the liquid crystal layer. In Case (2), the monomer 42 may be polymerized under application of a voltage less than the threshold voltage to the liquid crystal layer 40. In Case (3), the monomer 42 may be polymerized under application of no voltage to the liquid crystal layer 40. In Case (1), the tilt angle and/or alignment direction of the liquid crystal molecules 41 can be precisely controlled.

In the polymerization step, the light 32 is preferably applied to a substrate not including a color filter. If a substrate including a color filter is irradiated with the light 32, the light 32 may be absorbed by the color filter, lowering the reaction efficiency of the monomer 42. In terms of the reaction efficiency of the monomer 42, a pixel electrode and a common electrode are preferably transparent.

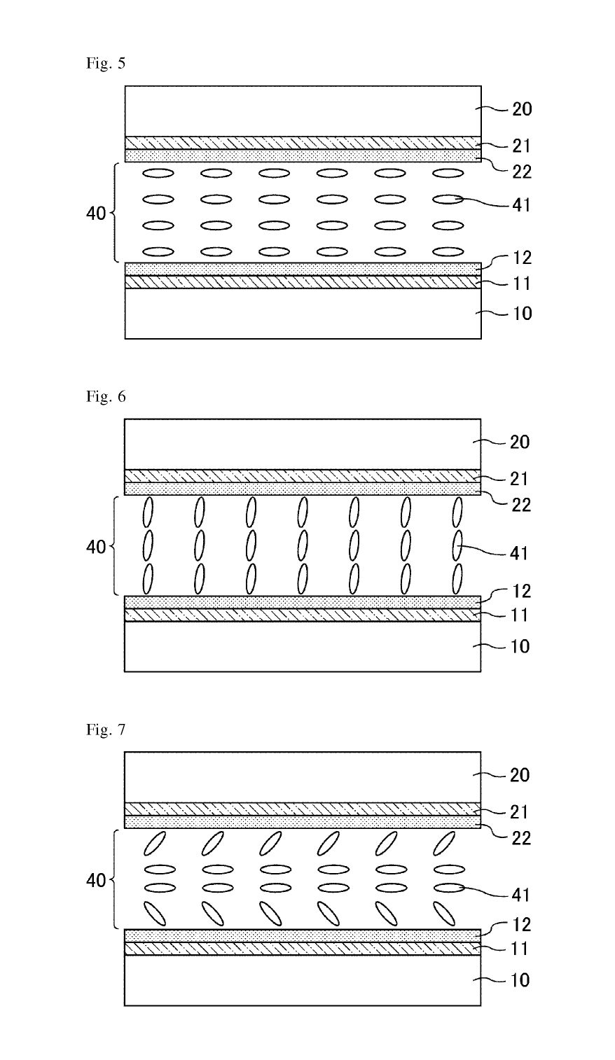

Preferably, the polymer layers 12 and 22 are respectively formed like a film covering the entire surface of the photoalignment films 11 and 21, as shown in FIGS. 5 to 7. More specifically, the polymer layers 12 and 22 are preferably formed densely to have a substantially uniform thickness on the photoalignment films 11 and 21, respectively. Alternatively, the polymer layers 12 and 22 may be formed on the photoalignment films 11 and 21 insularly. The polymer layers 12 and 22 may also have a non-uniform thickness. Or, the polymer layers 12 and 22 may be formed on the photoalignment films 11 and 21 to form a network through the liquid crystal layer 40. In other words, the polymer layers 12 and 22 may be integrated with each other.

Only one of the polymer layers 12 and 22 may be formed. Such an embodiment can be realized by formation of one of the photoalignment films 11 and 21 because the polymer layer is likely to be formed on the photoalignment film.

The polymer layers 12 and 22 contain a copolymer formed at least of the monomer (I) and the monomer (II). The arrangement of the repeating unit of the copolymer is not particularly limited, and may be random, block, or alternate arrangement.

The average molecular weight of polymers contained in the polymer layers 12 and 22 is not particularly limited, and may be, for example, similar to the number average molecular weight or weight average molecular weight of polymers formed by the conventional PSA technique.

After the above steps, the step of attaching a polarizer and the step of mounting a controlling unit, power supply unit, and back light unit are conducted. Thus, the liquid crystal display device of the present embodiment is produced.

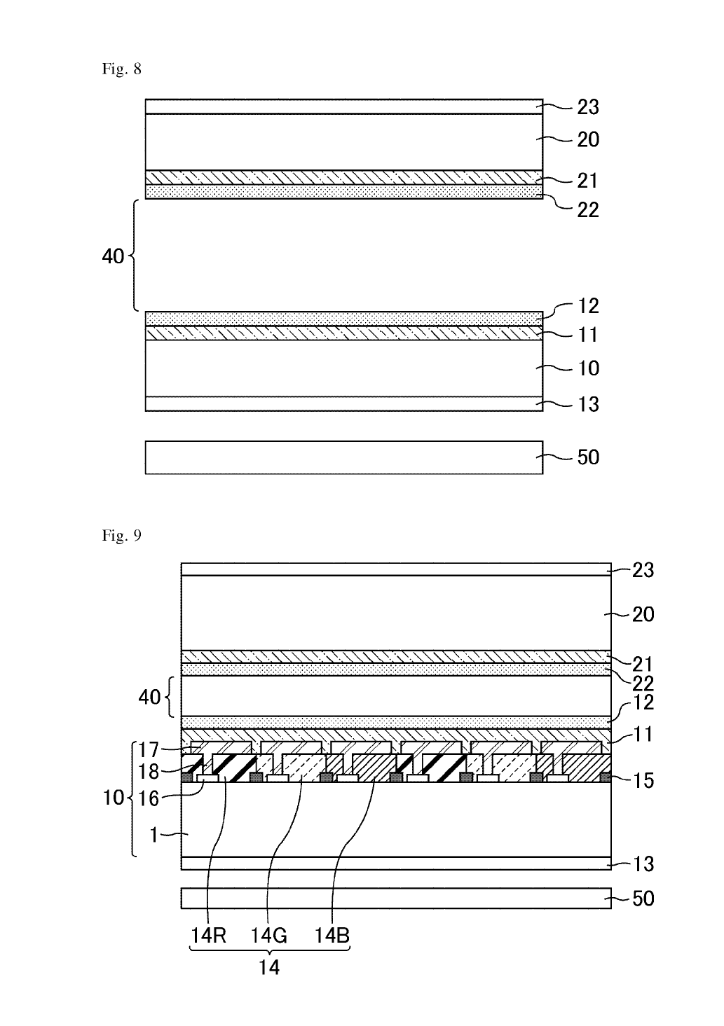

In the step of attaching a polarizer, as shown in FIG. 8, polarizers 13 and 23 are attached to the outer surface (opposite side of the liquid crystal layer 40) of the substrates 10 and 20, respectively. The polarizers 13 and 23 may be arranged in a parallel Nicol or cross Nicol state. From the standpoint of improving the front contrast ratio, the polarizers 13 and 23 are preferably arranged in a cross Nicol state. At least one of the polarizers 13 and 23 may be a circularly polarizing plate. The liquid crystal display device of the present embodiment may have a retardation plate. The liquid crystal display device of the present embodiment may be a normally white type or normally black type.

A back light unit 50 is provided at the rear side of the liquid crystal panel. Light from the back light unit 50 passes through the substrate 10, liquid crystal layer 40, and substrate 20 in the stated order. The back light unit 50 may be an edge-light type or direct type. The light source in the back light unit 50 is preferably a light emitting diode (LED), cold-cathode lamp (CCFL), or hot cathode fluorescent lamp (HCFL). The cold-cathode lamp and hot cathode fluorescent lamp have an illuminance stronger than that of LED in a wavelength range of UV light of 360 nm or more. In a case where a cold-cathode lamp or hot cathode fluorescent lamp is used as a light source of the back light unit in the liquid crystal display device of Comparative Embodiment 1, the liquid crystal molecules and/or photoalignment films may be deteriorated by light from the back light unit. As a result, problems occur, such as reduction of the VHR, deterioration of the residual DC voltage, and/or occurrence of image sticking. The image sticking is caused by an unnecessary reaction between monomers remaining in the liquid crystal layer after assembly of the device which generate radicals by photo-fries rearrangement and light from the back light unit. In the present embodiment, however, the monomer 42 is effectively prevented from being left in the liquid crystal layer 40. Accordingly, even in a case where a cold-cathode lamp or hot cathode fluorescent lamp is used as a light source, such problems are effectively prevented. In addition, since UV light (a trace of UV light of about 360 to 400 nm) from the cold-cathode lamp or hot cathode fluorescent lamp is absorbed by skeletons, such as benzophenone and benzyl skeletons, in the polymer layers 12 and 22, the intensity of the UV light reaching the liquid crystal layer 40 from the cold-cathode lamp or hot cathode fluorescent lamp can be attenuated. An LED emits UV light of about 400 nm (UV light of the wavelength in a range substantially from 390 to 400 nm). Such UV light from the LED is also absorbed by skeletons, such as benzophenone and benzyl skeletons, in the polymer layers 12 and 22, and therefore, the intensity of the UV light reaching the liquid crystal layer 40 from the LED can be attenuated. Accordingly, in a case where a light source used is a cold-cathode lamp, hot cathode fluorescent lamp, or LED, the effect of improving the long-term reliability can be exerted. Moreover, since these skeletons in the polymer layers 12 and 22 are immobilized in polymer molecules, these skeletons hardly abstract hydrogen from the photoalignment films 11 and 21 even when the skeletons absorb UV light from the cold-cathode lamp, hot cathode fluorescent lamp, or LED. Accordingly, even in a case where a light source used is a cold-cathode lamp, hot cathode fluorescent lamp, or LED, unnecessary generation of radicals and/or ions is effectively prevented.

The liquid crystal display device of the present embodiment may be a transmission, reflection, or transflective type. In the case of a transmission type device, the back light unit 50 is not needed. In the present embodiment, however, lowering of the VHR after backlight aging is effectively suppressed. The liquid crystal display device of the present embodiment therefore is suitable for transmission-type and transflective-type devices and preferably has the back light unit 50. In the case of a reflection-type or transflective-type device, the substrate 10 has a reflector for reflecting external light.

The liquid crystal display device of the present embodiment may have a COA structure as shown in FIG. 9. In this case, color filters 14 are formed in the substrate 10 and the substrate 20 does not contain a photoabsorbing resin, such as a color filter or UV-curable acrylic resin. The light from the back light unit 50 may reach the viewer side and pass through the substrate 20 to reach the liquid crystal layer 40. In the present embodiment, however, lowering of the VHR due to the light from the back light unit 50 is effectively suppressed. Accordingly, the COA structure is suitable for the present embodiment. As shown in FIG. 9, the substrate 10 may have an insulating substrate 1, TFTs 16 and wiring (not shown) on the insulating substrate 1, an interlayer insulating film (not shown) covering these components, BMs 15 and color filters 14 on the interlayer insulating film, and pixel electrodes 17 on the color filters 14. The pixel electrodes 17 are connected to the TFTs 16 through contact holes 18 formed in the color filters 14. The substrate 10 may further have an interlayer insulating film (not shown) on the color filters 14. The BMs 15 may be formed in the substrate 20. The color filters 14 include, for example, red, green, and blue color filters 14R, 14G, and 14B. The kind, number, and arrangement order of colors of the color filters 14 are not particularly limited.

The liquid crystal display device of the present embodiment may be a monochrome display or field sequential color display. In such a case, no color filter is needed.

Preferable application of the liquid crystal display device of the present embodiment includes mobile phones including smartphones, PCs in general including tablet PCs, TVs, digital signage, medical monitors, electronic books, and car navigation systems.

In the present embodiment, for example, components, weight ratio, and the like of monomers in the liquid crystal composition can be analyzed by liquid chromatography. Components of the material of the alignment film can be analyzed by time-of-flight secondary ion mass spectrometry (TOF-SIMS) performed on the surface of the photoalignment film.

### (Evaluation Test 1)

In the following, plural liquid crystal cells were actually produced as a liquid crystal panel in a liquid crystal display device according to Embodiment 1, and effects thereof were evaluated.

First, a pair of glass substrates each having a rectangular transparent electrode were provided. Both of the substrates did not have a photoabsorbing resin, such as a color filter or UV-curable acrylic resin.

Next, a composition for forming an alignment film was applied to the pair of substrates using a spin coater. The substrates were subjected to pre-baking under the condition of 80° C. for 5 minutes and then to post-baking under the condition of 200° C. for 60 minutes, thereby forming a photoalignment film on each substrate. The composition for forming an alignment film was a solution containing a polyamic acid or polyimide that is a material for forming an vertical alignment film and has a photoreactive functional group (specifically, a cinnamate group) in a side chain.

Next, each substrate was irradiated with polarized UV light having a peak wavelength of about 300 nm in a direction at 45° oblique to the principle surface of the substrate. Thus, the photoalignment treatment was conducted. The irradiation dose was set to 100 mJ/cm².

Next, a sealing material was applied to one substrate and beads were scattered on the other substrate. The one substrate was placed on the other substrate with beads present therebetween and the sealing material was then cured by heating, thereby bonding the substrates to each other. Next, a liquid crystal composition was injected from the inlet provided in a portion of the sealing material by vacuum injection and enclosed between the substrates. Liquid crystal compositions prepared were a composition containing at least one polymerizable monomer and nematic liquid crystal molecules having negative dielectric anisotropy (hereafter, referred to as a negative liquid crystal material) and a composition containing not a polymerizable monomer but a negative liquid crystal material.

In the present evaluation, polymerizable monomers represented by Formulae (1) to (3) were used. These monomers were all bifunctional monomers having two polymerizable groups, namely, polymerizable functional groups in a molecule. The polymerizable monomer represented by Formula (1) (hereafter, also referred to as a monomer (1)) was a bifunctional benzophenone methacrylate monomer. The polymerizable monomer represented by Formula (2) (hereafter, also referred to as a monomer (2)) was a bifunctional biphenyl methacrylate monomer. The polymerizable monomer represented by Formula (3) (hereafter, also referred to as a monomer (3)) was a bifunctional phenanthrene methacrylate monomer.

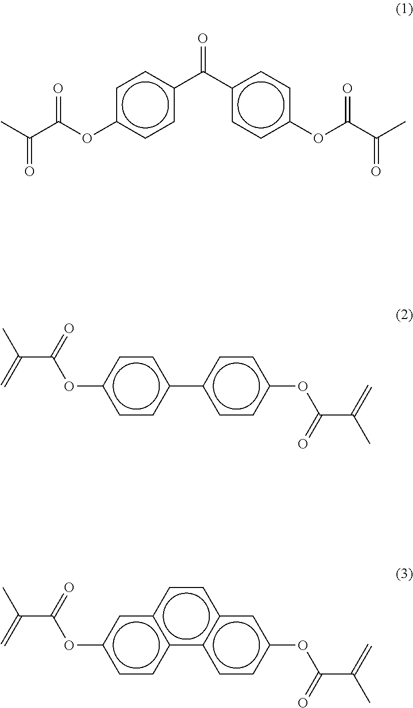

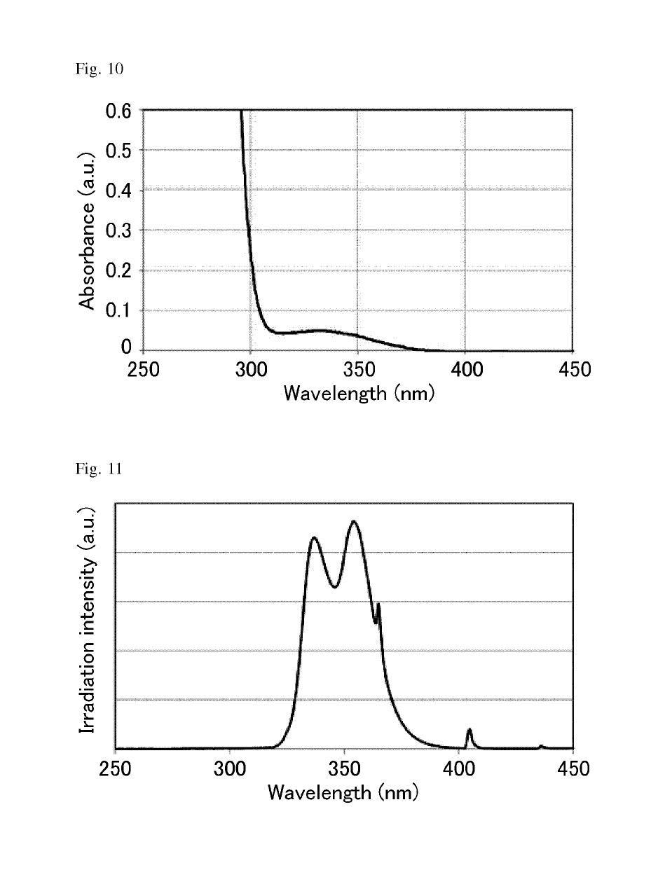

The monomer (1) can absorb light of less than 400 nm as shown in FIG. 10.

In the present evaluation test, five different liquid crystal cells (Samples 1 to 5) were prepared by changing the formulation of the liquid crystal composition. In Sample 1 (example), the monomers (1) and (2) were added to the negative liquid crystal material, and the resulting liquid crystal composition had a concentration of the monomer (1) of 0.05% by weight and a concentration of the monomer (2) of 0.3% by weight. In Sample 2 (example), the monomers (1) and (3) were added to the negative liquid crystal material, and the resulting liquid crystal composition had a concentration of the monomer (1) of 0.05% by weight and a concentration of the monomer (3) of 0.3% by weight. In Sample 3 (comparative example), only the monomer (2) was added to the negative liquid crystal material, and the resulting liquid crystal composition had a concentration of the monomer (2) of 0.3% by weight. In Sample 4 (comparative example), only the monomer (3) was added to the negative liquid crystal material, and the resulting liquid crystal composition had a concentration of the monomer (3) of 0.3% by weight. In Sample 5 (comparative example), no polymerizable monomer was added to the negative liquid crystal material.

After heating of the liquid crystal cell to 130° C., the liquid crystal cell was cooled to ambient temperature by blowing air.

Next, using an irradiation device including a black light as a light source and a cut-off filter, under application of no voltage, the liquid crystal cell was irradiated with UV light in a normal direction relative to the principle surface thereof for 15 minutes. The irradiation dose was substantially 160 mJ/cm². As shown in FIG. 11, the irradiation device emitted UV light having a peak wavelength within a range of 300 to 370 nm, and therefore, the monomer (1) can absorb the UV light sufficiently. The added monomers were thus polymerized, thereby completing formation of liquid crystal cells each with a polymer layer formed on the photoalignment film.

In the conventional PSA technique, for example, the monomer (2) or monomer (3) was solely used. Even in the case of using plural polymerizable monomers in combination, the monomer (2) and monomer (3) were simply mixed.

In contrast, in the present embodiment, as shown in Reaction Formula (b), a monomer that generates ketyl radicals (e.g., monomer (1)) is used. The ketyl radical generation efficiency by UV irradiation is higher than the radical generation efficiency by the photo-fries rearrangement due to UV irradiation. Accordingly, UV irradiation efficiently initiates a polymerization reaction, so that the reaction rate significantly improves in comparison with conventional cases. As a result, even in the case of using a photoalignment film containing a photoreactive functional group, a polymer layer can be formed without lowering the effect of the photoalignment treatment. In other words, a change of the pretilt angle or an increase in variation of the alignment axis derived from formation of a polymer layer is effectively suppressed.

Subsequently, the pretilt angle (°) of each of Samples 1 to 5 was measured by the crystal rotation method.

The voltage holding ratio (VHR) of each of Samples 1 to 5 was measured. The VHR (%) was determined by measuring the charge retention for 16.67 ms after application of 1 V of pulse voltage at 70° C. The VHR was measured using a LC material characteristics measurement system model 6254 (TOYO Corporation). The measurement of VHR (photodegradation test) was carried out twice, at the initial stage and at a stage after 1000 hours of electrification with photoirradiation, not through a polarizer, from a back light unit that includes a cold-cathode lamp (light source) having a greater intensity in the UV region than a light emitting diode.

Additionally, each of Samples 1 to 5 were measured for the residual DC voltage (rDC). The residual DC voltage (rDC) was determined by the flicker elimination method after application of the DC offset voltage (2 V) for 10 hours at 40° C.

Table 1 shows the measurement results.

TABLE 1

| | Added monomer and | Pretilt angle (°) | Pretilt angle (°) | VHR (%) | VHR (%) | rDC |
|---|---|---|---|---|---|---|
| Sample | amount thereof | before irradiation | after irradiation | at the initial stage | after 1000 hours | (mV) |
| 1 | (1) 0.05 wt % | 88.1 | 88.1 | 99.5 | 99.5 | −10 |
| | (2) 0.3 wt % | | | | | |
| 2 | (1) 0.05 wt % | 88.1 | 88.1 | 99.5 | 99.5 | −10 |
| | (3) 0.3 wt % | | | | | |
| 3 | (2) 0.3 wt % | 88.1 | 88.6 | 98.4 | 97.6 | 180 |
| 4 | (3) 0.3 wt % | 88.1 | 88.3 | 99.1 | 99.5 | 20 |
| 5 | No monomer added | 88.1 | 88.9 | 94.2 | 90.3 | 240 |

Table 1 shows the following facts.

Addition of 0.05% by weight of the monomer (1) having a benzophenone skeleton prevented a change of the pretilt angle before and after UV irradiation for monomer polymerization. In contrast, in the case of not using the monomer (1), the use of only the biphenyl monomer (2) allowed the pretilt angle to shift by 0.5° in the 90° direction, and the use of only the phenanthrene monomer (3) allowed the pretilt angle to shift by 0.2° in the 90° direction. Moreover, when a liquid crystal cell not at all containing monomers was irradiated with UV light, the pretilt angle became 88.9°. Based on these facts, presumably, the polymerization reaction by the photo-fries rearrangement has an insufficient polymerization rate so that formation of a polymer layer takes a long time. As a result, the pretilt angle shifted in the 90° direction by UV irradiation.

Addition of the monomer (1) allowed maintaining a high VHR of 99.5% at the initial stage (before aging). The use of only the monomer (2) or monomer (3) let the VHR be lowered in a range of 98% to the first half of 99%. In the case of not using a monomer, the VHR was lowered to 94%. Moreover, the VHR after aging for 1000 hours was not at all lowered in the case of adding the monomer (1). In contrast, the VHR became lower than the VHR at the initial stage in the case of using only the monomer (2) or no monomer.

The addition of the monomer (1) lowered the residual DC voltage to −10 mV. In the case of using only the monomer (2) or the monomer (3), the residual DC voltage was 180 mV or 20 mV, respectively, which were higher than that in the case of using the monomer (1).

These results show that a combination of a monomer used in the conventional PSA technique with the benzophenone monomer (1) can prevent a change of the pretilt angle between before and after UV irradiation for polymerization, maintain a high VHR both at the initial stage and after aging, and achieve a low residual DC voltage.

Table 2 shows the results of measurement of Samples 1 to 4 for the relation between the UV irradiation dose and the reaction ratio of the monomer (2) or (3).

TABLE 2

| | Irradiation dose (mJ/cm² ) | | | | | | |
|---|---|---|---|---|---|---|---|
| | 0 | 10 | 20 | 30 | 40 | 50 | 100 |
| (1) 0.05 wt % | 0 | 17 | 40 | 61 | 67 | 83 | 96 |
| (2) 0.3 wt % | | | | | | | |
| (1) 0.05 wt % | 0 | 90 | 100 | | | | |
| (3) 0.3 wt % | | | | | | | |
| (2) 0.3 wt % | 0 | 18 | 36 | 56 | 66 | 78 | 90 |
| (3) 0.3 wt % | 0 | 71 | 82 | 90 | 94 | 100 | |

The reaction ratio can be calculated using the following equation.

Reaction ratio (%)=(100−((Concentration of residual monomers after irradiation/Initial concentration of monomers)×100))

The ratio (Concentration of residual monomers after irradiation/Initial concentration of monomers) was calculated based on a ratio of the peak strength derived from the monomers monitored along with UV irradiation by liquid chromatography with the peak strength derived from the monomers in the initial state (before irradiation).

As shown in Table 2, the use of the monomer (1) and the monomer (3) in combination allowed the reaction ratio of the monomer (3) to reach 100% with an irradiation dose (50 mJ/cm² to 20 mJ/cm²) that is less than half of that in the case of using only the monomer (3). In the case of using the monomer (1) and the monomer (2) in combination, the reaction ratio of the monomer (2) achieved by the same irradiation dose was somewhat higher than the case of using only the monomer (2). In Samples 1 and 2 each including the monomer (1), the monomer (1) did not remain when the irradiation dose reached 10 mJ/cm². In Sample 1 formed of the monomers (1) and (2), the reaction ratio of the monomer (2) reached 100% when the irradiation dose reached substantially 160 mJ/cm².

The results in Table 2 show that a combination of especially the monomer (1) and a monomer having a phenanthrene skeleton significantly reduces the irradiation dose and/or shortens the irradiation time.

### (Evaluation Test 2)

Plural liquid crystal cells were produced in the same manner as in the evaluation test 1 except for the following changes. Specifically, changes were the use of a different pair of substrates, the use of different liquid crystal compositions, and the use of a solution that is a material for forming a horizontal alignment film and contains polyamic acid or polyimide having a photoreactive functional group (specifically, cinnamate group) in a side chain, as a composition for forming an alignment film. In the present evaluation test, the used substrates were a glass substrate including a pair of transparent comb-shaped electrodes and a plain glass substrate not having an electrode. The both substrates had no photoabsorbing resin such as a color filter or UV-curable resin. The conditions for alignment treatment and for UV irradiation for monomer polymerization were the same as those in the evaluation test 1.

In the present evaluation test, used instead of the negative liquid crystal material was nematic liquid crystal molecules having positive dielectric anisotropy (hereafter, referred to as a positive liquid crystal material). In addition to the monomers (1) to (3), polymerizable monomers (bifunctional monomers) represented by Formulae (4) to (6) were also used. These monomers were all bifunctional phenanthrene methacrylate monomers. Hereafter, the polymerizable monomers represented by Formulae (4), (5) and (6) are also referred to as monomers (4), (5), and (6).

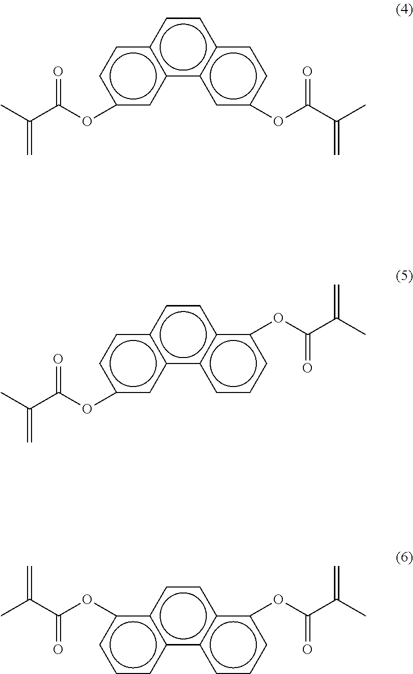

In the present evaluation test, 11 different liquid crystal cells (Samples 6 to 16) were produced by changing the formulation of the used liquid crystal compositions. In production of Sample 6 (example), the monomers (1) and (2) were added to the positive liquid crystal material, and the resulting liquid crystal composition had a concentration of the monomer (1) of 0.05% by weight and a concentration of the monomer (2) of 0.3% by weight. In production of Sample 7 (example), the monomers (1) and (3) were added to the positive liquid crystal material, and the resulting liquid crystal composition had a concentration of the monomer (1) of 0.05% by weight and a concentration of the monomer (3) of 0.3% by weight. In production of Sample 8 (example), the monomers (1) and (4) were added to the positive liquid crystal material, and the resulting liquid crystal composition had a concentration of the monomer (1) of 0.05% by weight and a concentration of the monomer (4) of 0.3% by weight. In production of Sample 9 (example), the monomers (1) and (5) were added to the positive liquid crystal material, and the resulting liquid crystal composition had a concentration of the monomer (1) of 0.05% by weight and a concentration of the monomer (5) of 0.3% by weight. In production of Sample 10 (example), the monomers (1) and (6) were added to the positive liquid crystal material, and the resulting liquid crystal composition had a concentration of the monomer (1) of 0.05% by weight and a concentration of the monomer (6) of 0.3% by weight. In production of Sample 11 (comparative example), only the monomer (2) was added to the positive liquid crystal material, and the resulting liquid crystal composition had a concentration of the monomer (2) of 0.3% by weight. In production of Sample 12 (comparative example), only the monomer (3) was added to the positive liquid crystal material, and the resulting liquid crystal composition had a concentration of the monomer (3) of 0.3% by weight. In production of Sample 13 (comparative example), only the monomer (4) was added to the positive liquid crystal material, and the resulting liquid crystal composition had a concentration of the monomer (4) of 0.3% by weight. In production of Sample 14 (comparative example), only the monomer (5) was added to the positive liquid crystal material, and the resulting liquid crystal composition had a concentration of the monomer (5) of 0.3% by weight. In production of Sample 15 (comparative example), only the monomer (6) was added to the positive liquid crystal material, and the resulting liquid crystal composition had a concentration of the monomer (6) of 0.3% by weight. In production of Sample 16 (comparative example), no polymerizable monomers were added to the positive liquid crystal material.

Each of Samples 6 to 16 was measured for variation of the initial alignment direction of liquid crystal molecules (hereafter, also referred to as variation of the alignment axis or simply, variation). Specifically, the initial alignment direction (°) was measured at arbitrary five points of the liquid crystal cell, and the maximum difference among the measured values was calculated.

Each of Samples 6 to 16 was measured for the VHR and the residual DC voltage in the same manner as in the evaluation test 1.

Table 3 shows the measurement results.

TABLE 3

| | | Variation (°) of | Variation (°) of | | | |
|---|---|---|---|---|---|---|
| | Added monomer and | alignment axis | alignment axis | VHR (%) | VHR (%) | rDC |
| Sample | amount thereof | before irradiation | after irradiation | at the initial stage | after 1000 hours | (mV) |
| 6 | (1) 0.05 wt % | 0.5 | 0.7 | 99.5 | 99.5 | −10 |
| | (2) 0.3 wt % | | | | | |
| 7 | (1) 0.05 wt % | 0.5 | 0.6 | 99.5 | 99.5 | −20 |
| | (3) 0.3 wt % | | | | | |
| 8 | (1) 0.05 wt % | 0.5 | 0.5 | 99.5 | 99.5 | −10 |
| | (4) 0.3 wt % | | | | | |
| 9 | (1) 0.05 wt % | 0.5 | 0.6 | 99.5 | 99.5 | −10 |
| | (5) 0.3 wt % | | | | | |
| 10 | (1) 0.05 wt % | 0.5 | 0.6 | 99.5 | 99.5 | −10 |
| | (6) 0.3 wt % | | | | | |
| 11 | (2) 0.3 wt % | 0.5 | 1.1 | 98.2 | 96.3 | 190 |
| 12 | (3) 0.3 wt % | 0.5 | 0.8 | 99.1 | 99.4 | 20 |
| 13 | (4) 0.3 wt % | 0.5 | 0.8 | 99.2 | 99.5 | 20 |
| 14 | (5) 0.3 wt % | 0.5 | 0.9 | 99.2 | 99.5 | 30 |
| 15 | (6) 0.3 wt % | 0.5 | 0.9 | 99.1 | 99.4 | 20 |
| 16 | No monomer added | 0.5 | 3.8 | 92.7 | 86.5 | 320 |

Table 3 shows the following facts.

Addition of 0.05% by weight of the monomer (1) having a benzophenone skeleton suppressed an increase in the variation of the alignment axis before and after UV irradiation for monomer polymerization. In the case of not adding the monomer (1), the use of only the biphenyl monomer (2) resulted in the variation of 1° or more. Even in the case of using any of the phenanthrene monomers (3) to (6), a variation of 0.8° to 0.9° was observed. Moreover, in a case where a liquid crystal cell not containing monomers was irradiated with UV light, a variation increased to 3.8°. Based on these facts, presumably, the polymerization reaction by the photo-fries rearrangement has an insufficient polymerization rate so that formation of a polymer layer takes a long time. As a result, UV irradiation increased the degree of a variation of the alignment axis.

In evaluation of the VHR and the residual DC voltage, the same tendency as in the evaluation test 1 was found. The addition of the monomer (1) led to the best result.

These results show that the use of the benzophenone monomer (1) enables to suppress variation of the alignment axis between before and after UV irradiation for polymerization, maintain a high VHR both at the initial stage and after aging, and achieve a low residual DC voltage.

Table 4 shows the results of measuring Samples 8 to 10 and 13 to 15 for measuring the relation between the UV irradiation dose and the reaction ratio of the monomer (4), (5), or (6). The reaction ratio was measured by the method as mentioned in the evaluation test 1.

TABLE 4

| | Irradiation dose (mJ/cm² ) | | | | | | |
|---|---|---|---|---|---|---|---|
| | 0 | 10 | 20 | 30 | 40 | 50 | 100 |
| (1) 0.05 wt % | 0 | 93 | 100 | | | | |
| (4) 0.3 wt % | | | | | | | |
| (1) 0.05 wt % | 0 | 97 | 100 | | | | |
| (5) 0.3 wt % | | | | | | | |
| (1) 0.05 wt % | 0 | 96 | 100 | | | | |
| (6) 0.3 wt % | | | | | | | |
| (4) 0.3 wt % | 0 | 66 | 80 | 91 | 94 | 100 | |
| (5) 0.3 wt % | 0 | 73 | 85 | 93 | 100 | | |
| (6) 0.3 wt % | 0 | 72 | 81 | 88 | 97 | 100 | |

As shown in Table 4, a combination of the monomer (1) and one of the phenanthrene monomers (4) to (6) allowed the reaction ratio of the one of the monomers (4) to (6) to reach 100% with the irradiation dose of 20 mJ/cm², regardless of the substitution site of a polymerizable group in the phenanthrene monomer. This shows that the use of the monomer (1), especially the use of the monomer (1) and a monomer having a phenanthrene skeleton in combination reduces the irradiation dose and/or shortens the irradiation time.

### (Evaluation Test 3)

Plural liquid crystal cells were produced in the same manner as in the evaluation test 1 except that a different polymerizable monomer was used. The conditions for alignment treatment and for UV irradiation for polymerization were the same as those in the evaluation test 1.

In the present evaluation test, used instead of the monomer (1) was a polymerizable monomer (bifunctional monomer) represented by Formula (7). The polymerizable monomer represented by Formula (7) (hereafter, also referred to as a monomer (7)) is a bifunctional benzyl methacrylate monomer.

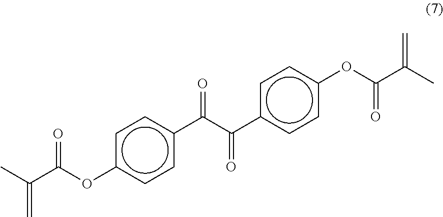

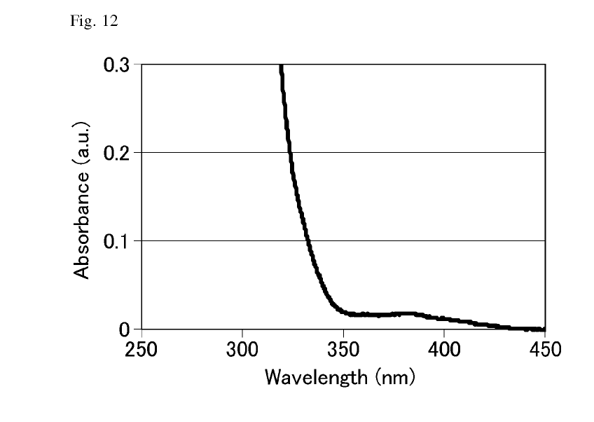

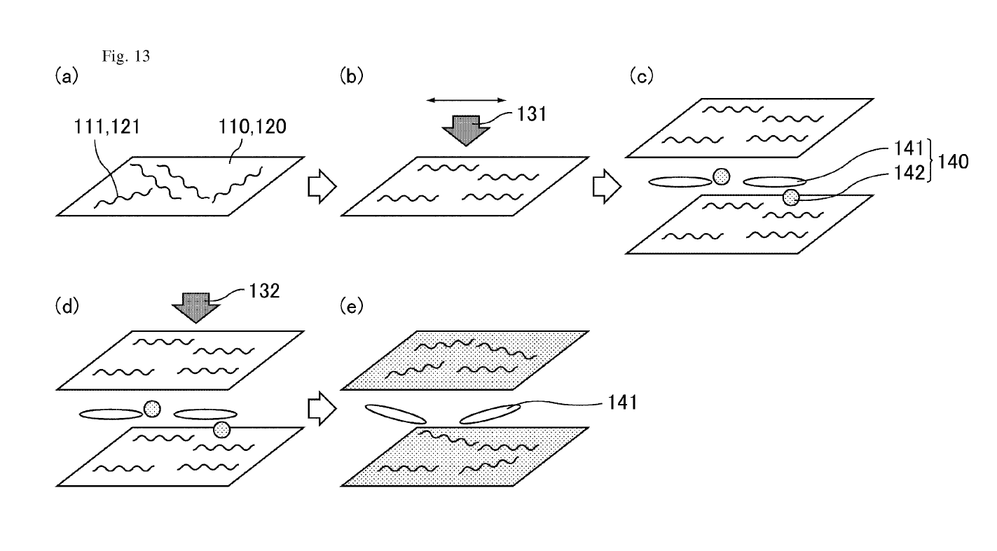

The monomer (7) can absorb light of less than 450 nm, as shown in FIG. 12.

In the present evaluation test, two different liquid crystal cells (Samples 17 and 18) were produced by changing the formulation of the liquid crystal composition. In production of Sample 17 (example), the monomers (7) and (2) were added to the negative liquid crystal material, and the resulting liquid crystal composition had a concentration of the monomer (7) of 0.05% by weight and a concentration of the monomer (2) of 0.3% by weight. In production of Sample 18 (example), the monomers (7) and (3) were added to the negative liquid crystal material, and the resulting liquid crystal composition had a concentration of the monomer (7) of 0.05% by weight and a concentration of the monomer (3) of 0.3% by weight.

Each of produced Samples 17 and 18 was measured in the same manner as in the evaluation test 1 for the pretilt angle, VHR, and residual DC voltage.

Table 5 shows the measurement results.

TABLE 5

| | Added monomer and | Pretilt angle (°) | Pretilt angle (°) | VHR (%) | VHR (%) | rDC |
|---|---|---|---|---|---|---|
| Sample | amount thereof | before irradiation | after irradiation | at the initial stage | after 1000 hours | (mV) |
| 17 | (7) 0.05 wt % | 88.1 | 88.2 | 99.5 | 99.5 | −20 |
| | (2) 0.3 wt % | | | | | |
| 18 | (7) 0.05 wt % | 88.1 | 88.1 | 99.5 | 99.5 | −30 |
| | (3) 0.3 wt % | | | | | |

Table 5 shows the following results.

Addition of 0.05% by weight of the monomer (7) having a benzyl skeleton also prevented a change of the pretilt angle between before and after UV irradiation for monomer polymerization as in the case of a benzophenone monomer.

Addition of the monomer (7) kept a high VHR of 99.5% at the initial stage (before aging). Moreover, addition of the monomer (7) did not at all allow lowering of the VHR after aging for 1000 hours.

Addition of the monomer (7) kept the residual DC voltage as low as −20 mV or −30 mV.

These results show that a combination of a monomer used in the conventional PSA technique with the benzyl monomer (7) enables to prevent a change of the pretilt angle between before and after UV irradiation for polymerization, maintain a high VHR both at the initial stage and after aging, and achieve a low residual DC voltage.

Table 6 shows the results of measuring Samples 3, 4, 17, and 18 for the relation between the UV irradiation dose and the reaction ratio of the monomer (2) or (3). The method of measuring the reaction ratio was already mentioned in the evaluation test 1.

TABLE 6

| | Irradiation dose (mJ/cm²) | | | | | | |
|---|---|---|---|---|---|---|---|
| | 0 | 10 | 20 | 30 | 40 | 50 | 100 |
| (7) 0.05 wt % | 0 | 18 | 38 | 62 | 73 | 86 | 100 |
| (2) 0.3 wt % | | | | | | | |
| (7) 0.05 wt % | 0 | 87 | 94 | 100 | | | |
| (3) 0.3 wt % | | | | | | | |
| (2) 0.3 wt % | 0 | 18 | 36 | 56 | 66 | 78 | 90 |
| (3) 0.3 wt % | 0 | 71 | 82 | 90 | 94 | 100 | |

As shown in Table 6, a combination of the monomer (7) having a benzyl skeleton and the monomer (3) allowed the reaction ratio of the monomer (3) to reach 100% with the irradiation dose (50 to 30 mJ/cm²) that is about half the irradiation dose in the case of using only the monomer (3). In the case of a combination of the monomers (7) and (2), compared to the case of using only the monomer (2), the reaction ratio of the monomer (2) was higher when the irradiation dose was the same. In Samples 17 and 18 including the monomer (7), the monomer (7) did not remain when the irradiation dose reached 10 mJ/cm².

The results in Table 6 show that a combination of especially the monomer (7) and a monomer having a phenanthrene skeleton significantly reduces the irradiation dose and/or shortens the irradiation time.

### (Evaluation Test 4)

Plural liquid crystal cells were produced in the same manner as in the evaluation test 2, except that different polymerizable monomers were used. The conditions for alignment treatment and for UV irradiation for polymerization of monomers were the same as those in the evaluation test 1.

In the present evaluation test, used instead of the monomer (1) was the monomer (7).

In the present evaluation test, five different liquid crystal cells (Samples 19 to 23) were produced by changing the formulation of the liquid crystal composition. In production of Sample 19 (example), the monomers (7) and (2) were added to the positive liquid crystal material, and the resulting liquid crystal composition had a concentration of the monomer (7) of 0.05% by weight and a concentration of the monomer (2) of 0.3% by weight. In production of Sample 20 (example), the monomers (7) and (3) were added to the positive liquid crystal material, and the resulting liquid crystal composition had a concentration of the monomer (7) of 0.05% by weight and a concentration of the monomer (3) of 0.3% by weight. In production of Sample 21 (example), the monomers (7) and (4) were added to the positive liquid crystal material, and the resulting liquid crystal composition had a concentration of the monomer (7) of 0.05% by weight and a concentration of the monomer (4) of 0.3% by weight. In production of Sample 22 (example), the monomers (7) and (5) were added to the positive liquid crystal material, and the resulting liquid crystal composition had a concentration of the monomer (7) of 0.05% by weight and a concentration of the monomer (5) of 0.3% by weight. In production of Sample 23 (example), the monomers (7) and (6) were added to the positive liquid crystal material, and the resulting liquid crystal composition had a concentration of the monomer (7) of 0.05% by weight and a concentration of the monomer (6) of 0.3% by weight.

Each of Samples 19 to 23 was measured for the variation of the alignment axis, VHR, and the residual DC voltage in the same manner as in the evaluation tests 1 and 2.

Table 7 shows the measurement results.

TABLE 7

| | | Variation (°) of | Variation (°) of | VHR (%) | VHR (%) | |
|---|---|---|---|---|---|---|
| | Added monomer and | alignment axis | alignment axis | at the | after | rDC |
| Sample | amount thereof | before irradiation | after irradiation | initial stage | 1000 hours | (mV) |
| 19 | (7) 0.05 wt % | 0.5 | 0.8 | 99.5 | 99.5 | −10 |
| | (2) 0.3 wt % | | | | | |
| 20 | (7) 0.05 wt % | 0.5 | 0.6 | 99.5 | 99.5 | −20 |
| | (3) 0.3 wt % | | | | | |
| 21 | (7) 0.05 wt % | 0.5 | 0.6 | 99.5 | 99.5 | −30 |
| | (4) 0.3 wt % | | | | | |
| 22 | (7) 0.05 wt % | 0.5 | 0.6 | 99.5 | 99.5 | −30 |
| | (5) 0.3 wt % | | | | | |
| 23 | (7) 0.05 wt % | 0.5 | 0.6 | 99.5 | 99.5 | −20 |
| | (6) 0.3 wt % | | | | | |

Table 7 shows the following facts.

Addition of 0.05% by weight of the monomer (7) having a benzyl skeleton suppressed an increase in the variation of the alignment axis between before and after UV irradiation for monomer polymerization, as in the case of the benzophenone monomer.

Addition of the monomer (7) kept a high VHR of 99.5% at the initial stage (before aging). Moreover, addition of the monomer (7) did not at all allow lowering of the VHR after aging for 1000 hours.

Addition of the monomer (7) kept the residual DC voltage low as −10 mV to −30 mV.

These results show that a combination of a monomer used in the conventional PSA technique with the benzyl monomer (7) enables to suppress a variation of the alignment axis, maintain a high VHR both at the initial stage and after aging, and achieve a low residual DC voltage.

Table 8 shows the results of measuring Samples 21 to 23 for the relation between the UV irradiation dose and the reaction ratio of the monomer (4), (5), or (6). The method of measuring the reaction ratio was already mentioned in the evaluation test 1.

TABLE 8

| | Irradiation dose (mJ/cm² ) | | | | | | |
|---|---|---|---|---|---|---|---|
| | 0 | 10 | 20 | 30 | 40 | 50 | 100 |
| (7) 0.05 wt % | 0 | 90 | 100 | | | | |
| (4) 0.3 wt % | | | | | | | |
| (7) 0.05 wt % | 0 | 86 | 95 | 100 | | | |
| (5) 0.3 wt % | | | | | | | |
| (7) 0.05 wt % | 0 | 91 | 100 | | | | |
| (6) 0.3 wt % | | | | | | | |
| (4) 0.3 wt % | 0 | 66 | 80 | 91 | 94 | 100 | |
| (5) 0.3 wt % | 0 | 73 | 85 | 93 | 100 | | |
| (6) 0.3 wt % | 0 | 72 | 81 | 88 | 97 | 100 | |

As shown in Table 8, a combination of the monomer (7) and one of the phenanthrene monomers (4) to (6) allowed the reaction ratio of the one of the phenanthrene monomers (4) to (6) to reach 100% with the irradiation dose of 20 or 30 mJ/cm² regardless of the substitution site of a polymerizable group of the phenanthrene monomer. This shows that the use of the monomer (7), especially the use of the monomer (7) and a monomer having a phenanthrene skeleton in combination reduces the irradiation dose and/or shortens the irradiation time, as in the case of using the monomer (1).

### (Evaluation Test 5)

Plural liquid crystal cells were produced in the same manner as in the evaluation test 1, except that different polymerizable monomers were used. The conditions for alignment treatment and for UV irradiation for polymerization of monomers were the same as those in Evaluation test 1.

In the present evaluation test, used instead of the monomers (2) and (3) was a polymerizable monomer (bifunctional monomer) represented by Formula (8). The polymerizable monomer represented by Formula (8) (hereafter, also referred to as a monomer (8)) is a bifunctional naphthalene methacrylate monomer.

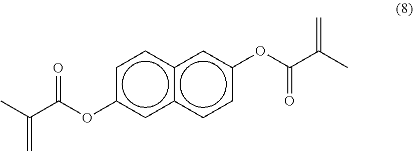

In the present evaluation test, three different liquid crystal cells (Samples 24 to 26) were produced by changing the formulation of the liquid crystal composition. In production of Sample 24 (example), the monomers (1) and (8) were added to the negative liquid crystal material, and the resulting liquid crystal composition had a concentration of the monomer (1) of 0.05% by weight and a concentration of the monomer (8) of 0.3% by weight. In production of Sample 25 (example), the monomers (7) and (8) were added to the negative liquid crystal material, and the resulting liquid crystal composition had a concentration of the monomer (7) of 0.05% by weight and a concentration of the monomer (8) of 0.3% by weight. In production of Sample 26 (comparative example), only the monomer (8) was added to the negative liquid crystal material, and the resulting liquid crystal composition had a concentration of the monomer (8) of 0.3% by weight.

Each of Samples 24 to 26 was measured for the pretilt angle, VHR, and residual DC voltage in the same manner as in the evaluation test 1.

Table 9 shows the measurement results.

TABLE 9

| | Added monomer | Pretilt angle (°) | Pretilt angle (°) | VHR (%) | VHR (%) | rDC |
|---|---|---|---|---|---|---|
| Sample | and amount thereof | before irradiation | after irradiation | at the initial stage | after 1000 hours | (mV) |
| 24 | (1) 0.05 wt % | 88.1 | 88.2 | 99.5 | 99.5 | −10 |
| | (8) 0.3 wt % | | | | | |
| 25 | (7) 0.05 wt % | 88.1 | 88.1 | 99.5 | 99.5 | −10 |
| | (8) 0.3 wt % | | | | | |
| 26 | (8) 0.3 wt % | 88.1 | 88.5 | 98.9 | 98.1 | 30 |

Table 9 shows the following facts.

In a case where the monomer (8) was used, addition of 0.05% by weight of the monomer (1) or (7) having a structure of abstracting hydrogen prevented a change of the pretilt angle before and after UV irradiation for polymerization of monomers.

Addition of the monomer (1) or (7) also maintained a high VHR of 99.5% at the initial stage (before aging). Moreover, addition of the monomer (7) did not at all allow lowering of the VHR after aging for 1000 hours.

These results show that a combination of the monomer (8) used in the conventional PSA technique with the monomer (1) or (7) having a structure of abstracting hydrogen enables to prevent a change of the pretilt angle between before and after UV irradiation for polymerization, maintain a high VHR both at the initial stage and after aging, and achieve a low residual DC voltage.

Table 10 shows the results of measuring Samples 24 to 26 for the relation between the UV irradiation dose and the reaction ratio of the monomer (8). The method of measuring the reaction ratio was already mentioned in the evaluation test 1.

TABLE 10

| | Irradiation dose (mJ/cm²) | | | | | | |
|---|---|---|---|---|---|---|---|
| | 0 | 10 | 20 | 30 | 40 | 50 | 100 |
| (1) 0.05 wt % | 0 | 74 | 90 | 98 | 100 | | |
| (8) 0.3 wt % | | | | | | | |
| (7) 0.05 wt % | 0 | 75 | 90 | 96 | 100 | | |
| (8) 0.3 wt % | | | | | | | |
| (8) 0.3 wt % | 0 | 45 | 68 | 82 | 89 | 94 | 100 |

As shown in Table 10, even in a case where the naphthalene monomer (8) was used as a second monomer, a combination of the monomer (8) with the monomer (1) or (7) having a structure of abstracting hydrogen achieved 100% of the reaction ratio of the monomer (8) with the irradiation dose that is about half the irradiation dose in the case of using only the monomer (8).

### REFERENCE SIGNS LIST

10, 20, 110, 120: substrate
11, 21, 111, 121: photoalignment film
12, 22: polymer layer
13, 23: polarizer
14: color filter
14R: red color filter
14G: green color filter
14B: blue color filter
15: BM
16: TFT
17: pixel electrode
18: contact hole
31, 32: light
40, 140: liquid crystal layer
41, 141: liquid crystal molecule
42, 142: polymerizable monomer
50: back light unit
131: polarized UV light
132: UV light (not polarized)

1. A liquid crystal display device comprising:
a first substrate;
a second substrate;
a photoalignment film provided on at least one of the first and second substrates;
a polymer layer provided on the photoalignment film; and
a liquid crystal layer provided between the first and second substrates,
the polymer layer containing a polymer having a monomer unit derived from two or more kinds of polymerizable monomers,
the two or more kinds of polymerizable monomers including at least a polymerizable monomer represented by Formula (I): 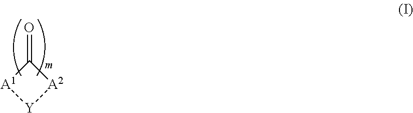
wherein A¹ and A² may be the same as or different from each other and each represent a benzene ring, biphenyl ring, or C1-C12 linear or branched alkyl or alkenyl group,
one of A¹ and A² represents a benzene or biphenyl ring,
at least one of A¹ and A² include a -Sp¹-P¹ group,
a hydrogen atom on A¹ and A² may be replaced by a -Sp¹-P¹ group, halogen atom, —CN group, —NO₂ group, —NCO group, —NCS group, —OCN group, —SCN group, —SF₅ group, or C1-C12 linear or branched alkyl, alkenyl, or aralkyl group,
two hydrogen atoms bonded to two adjacent carbons in A¹ and A² may be replaced by a C1-C12 linear or branched alkylene or alkenylene group to form a ring structure,
a hydrogen atom on the alkyl, alkenyl, alkylene, alkenylene, or aralkyl group in A¹ and A² may be replaced by a -Sp¹-P¹ group,
a —CH₂— group on the alkyl, alkenyl, alkylene, alkenylene, or aralkyl group in A¹ and A² may be substituted with a —O—, —S—, —NH—, —CO—, —COO—, —OCO—, —O—COO—, —OCH₂—, —CH₂O—, —SCH₂—, —CH₂S—, —N(CH₃)—, —N(C₂H₅)—, —N(C₃H₇)—, —N(C₄H₉)—, —CF₂O—, —OCF₂—, —CF₂S—, —SCF₂—, —N(CF₃)—, —CH₂CH₂—, —CH₂CF₂—, —CF₂CH₂—, —CF₂CF₂—, —CH═CH—, —CF═CF—, —C≡C—, —CH═CH—COO—, or —OCO—CH═CH— group, provided that oxygen, sulfur, and nitrogen atoms are not adjacent to one another,
P¹ represents a polymerizable group,
Sp¹ represents a C1-C6 linear, branched, or cyclic alkylene or alkyleneoxy group or a direct bond,
m represents 1 or 2,
a dotted line between A¹ and Y and a dotted line between A² and Y represent an optional bond between A¹ and A² via Y, and
Y represents a —CH₂—, —CH₂CH₂—, —CH═CH—, —O—, —S—, —NH—, —N(CH₃)—, —N(C₂H₅)—, —N(C₃H₇)—, —N(C₄H₉)—, —OCH₂—, —CH₂O—, —SCH₂—, or —CH₂S— group or a direct bond; and
a polymerizable monomer represented by Formula (II):
P³—S³-A³-(Z³-A⁴)ₙ-S⁴—P⁴ (II)
wherein
P³ and P⁴ may be the same as or different from each other, and each represent an acryloyloxy, methacryloyloxy, acryloylamino, methacryloylamino, vinyl, or vinyloxy group,
A³ and A⁴ may be the same as or different from each other, and each represent a 1,4-phenylene, 4,4′-biphenyl, naphthalene-2,6-diyl, phenanthrene-2,7-diyl, phenanthrene-3,6-diyl, phenanthrene-3,8-diyl, or phenanthrene-1,8-diyl group,
Z³ may be the same as or different from each other, and each represent a —COO—, —OCO—, —O—, —CO—, —NHCO—, —CONH—, or —S— group or a direct bond between A³ and A⁴ or between A⁴ and A⁴,
n represents 0, 1, 2, or 3,
S³ and S⁴ may be the same as or different from each other, and each represent a —(CH₂)ₘ— group (m representing a natural number satisfying 1≦m≦6), a —(CH₂—CH₂—O)ₘ— group (m representing a natural number satisfying 1≦m≦6), or a direct bond between P³ and A³, between A³ and P⁴, or between A⁴ and P⁴, and
a hydrogen atom on A³ and A⁴ may be replaced by a halogen or methyl group.

2. The liquid crystal display device according to claim 1,
wherein the polymerizable monomer represented by Formula (I) is a polymerizable monomer represented by any one of Formulae (I-1) to (I-6) mentioned below; 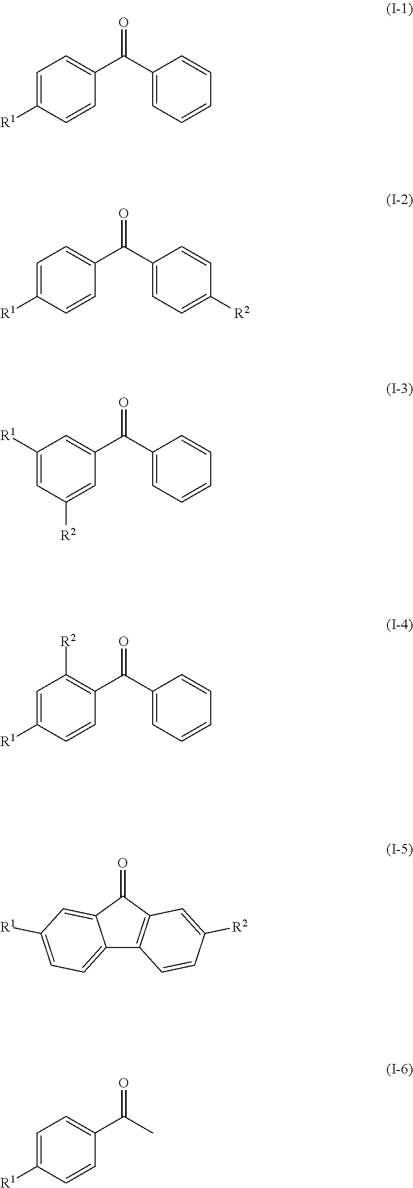
wherein
R¹ and R² may be the same as or different from each other, and each represent a -Sp¹-P¹ group, hydrogen atom, halogen atom, —CN group, —NO₂ group, —NCO group, —NCS group, —OCN group, —SCN group, —SF₅ group, C1-C12 linear or branched alkyl or aralkyl group, phenyl group, or biphenyl group,
at least one of R¹ and R² have a -Sp¹-P¹ group,
P¹ represents an acryloyloxy, methacryloyloxy, vinyl, vinyloxy, acryloylamino, methacryloylamino group,
Sp¹ represents a C1-C6 linear, branched, or cyclic alkylene or alkyleneoxy group or a direct bond,
when R¹ and R² each represent a phenyl, biphenyl, or C1-C12 linear or branched alkyl or aralkyl group, a hydrogen atom on R¹ and R² may be replaced by a fluorine atom, chlorine atom, or -Sp¹-P¹ group, and
a —CH₂— group on R¹ and R² may be substituted with a —O—, —S—, —NH—, —CO—, —COO—, —OCO—, —O—COO—, —OCH₂—, —CH₂O—, —SCH₂—, —CH₂S—, —N(CH₃)—, —N(C₂H₅)—, —N(C₃H₇)—, —N(C₄H₉)—, —CF₂O—, —OCF₂—, —CF₂S—, —SCF₂—, —N(CF₃)—, —CH₂CH₂—, —CF₂CH₂—, —CH₂CF₂—, —CF₂CF₂—, —CH═CH—, —CF═CF—, —C≡C—, —CH═CH—COO—, or —OCO—CH═CH— group, provided that oxygen, sulfur, and nitrogen atoms are not adjacent to one another.

3. The liquid crystal display according to claim 1,
wherein the polymerizable monomer represented by Formula (I) is a polymerizable monomer represented by any of Formulae (I-7) to (I-8) mentioned below; 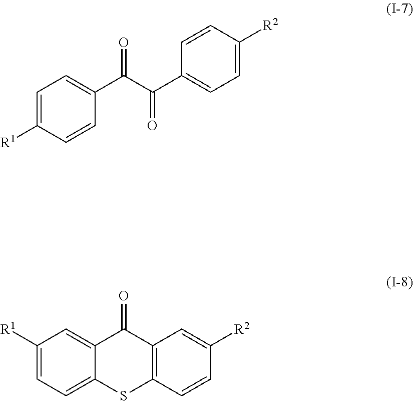
wherein
R¹ and R² may be the same as or different from each other, and each represent a -Sp¹-P¹ group, hydrogen atom, halogen atom, —CN group, —NO₂ group, —NCO group, —NCS group, —OCN group, —SCN group, —SF₅ group, C1-C12 linear or branched alkyl or aralkyl group, phenyl group, or biphenyl group,
at least one of R¹ and R² have a -Sp¹-P¹ group,
P¹ represents an acryloyloxy, methacryloyloxy, vinyl, vinyloxy, acryloylamino, or methacryloylamino group,
Sp¹ represents a C1-C6 linear, branched, or cyclic alkylene or alkyleneoxy group, or a direct bond,
when R¹ and R² each represent a phenyl, biphenyl, or a C1-C12 linear or branched alkyl or aralkyl group, a hydrogen atom on R¹ and R² may be replaced by a fluorine atom, chlorine atom, or -Sp¹-P¹ group, and
a —CH₂— group on R¹ and R² may be substituted with a —O—, —S—, —NH—, —CO—, —COO—, —OCO—, —O—COO—, —OCH₂—, —CH₂O—, —SCH₂—, —CH₂S—, —N(CH₃)—, —N(C₂H₅)—, —N(C₃H₇)—, —N(C₄H₉)—, —CF₂O—, —OCF₂—, —CF₂S—, —SCF₂—, —N(CF₃)—, —CH₂CH₂—, —CF₂CH₂—, —CH₂CF₂—, —CF₂CF₂—, —CH═CH—, —CF═CF—, —C≡C—, —CH═CH—COO—, or —OCO—CH═CH— group, provided that oxygen, sulfur, and nitrogen atoms are not adjacent to one another.

4. The liquid crystal display device according to claim 2,
wherein P¹ represents a methacryloyloxy group.

5. The liquid crystal display device according to claim 2,
wherein A³ represents a phenanthrene-2,7-diiyl, phenanthrene-3,6-diyl, phenanthrene-3,8-diyl, or phenanthrene-1,8-diyl group,
P³ and P⁴ both represent a methacryloxy group, and
n represents 0.

6. The liquid crystal display device according to claim 3,
wherein A³ represents a phenanthrene-2,7-diyl, phenanthrene-3,6-diyl, phenanthrene-3,8-diyl, or phenanthrene-1,8-diyl group,
P³ and P⁴ both represent a methacryloxy group, and
n represents 0.

7. The liquid crystal display device according to claim 2,
wherein A³ and A⁴ both represent a 1,4-phenylene group,
P³ and P⁴ both represent a methacryloxy group, and
n represents 1.

8. The liquid crystal display device according to claim 3,
wherein A³ and A⁴ both represent a 1,4-phenylene group,
P³ and P⁴ both represent a methacryloxy group, and
n represents 1.

9. The liquid crystal display device according to claim 1,
wherein the photoalignment film contains at least one of a compound having at least one photoreactive functional group selected from the group consisting of cinnamate, chalcone, coumarin, azobenzene, tolan, and stilbene groups, and derivatives thereof.

10. The liquid crystal display device according to claim 1, further comprising a back light unit.

11. The liquid crystal display device according to claim 1,
wherein one of the first and second substrates includes a color filter and a switching element.

12. A method of producing a liquid crystal display device, comprising the steps of:
providing a first substrate and a second substrate;
forming a photoalignment film on at least one of the first and second substrates;
forming a liquid crystal layer containing two or more kinds of polymerizable monomers between the first and second substrates after the formation of the photoalignment film; and
forming a polymer layer on the photoalignment film by polymerizing the two or more kinds of polymerizable monomers,
wherein the two or more kinds of polymerizable monomers include at least a polymerizable monomer represented by Formula (I); 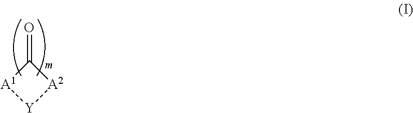
wherein A¹ and A² are the same as or different from each other, and each represent a benzene ring, biphenyl ring, or C1-C12 linear or branched alkyl or alkenyl group,
one of A¹ and A² represents a benzene or biphenyl ring,
at least one of A¹ and A² has a -Sp¹-P¹ group,
a hydrogen atom on A¹ and A² each may be replaced by a -Sp¹-P¹ group, halogen atom, —CN group, —NO₂ group, —NCO group, —NCS group, —OCN group, —SCN group, —SF₅ group, or C1-C12 linear or branched alkyl, alkenyl, or aralkyl group,
two hydrogen atoms bonded to two adjacent carbons in A¹ and A² may be replaced by a C1-C12 linear or branched alkylene or alkenylene group to form a ring structure,
a hydrogen atom on the alkyl, alkenyl, alkylene, alkenylene, or aralkyl group in A¹ and A² may be substituted with a -Sp¹-P¹ group,
a —CH₂— group on the alkyl, alkenyl, alkylene, alkenylene, or aralkyl group in A¹ and A² may be substituted with a —O—, —S—, —NH—, —CO—, —COO—, —OCO—, —O—COO—, —OCH₂—, —CH₂O—, —SCH₂—, —CH₂S—, —N(CH₃)—, —N(C₂H₅)—, —N(C₃H₇)—, —N(C₄H₉)—, —CF₂O—, —OCF₂—, —CF₂S—, —SCF₂—, —N(CF₃)—, —CH₂CH₂—, —CH₂CF₂—, —CF₂CH₂—, —CF₂CF₂—, —CH═CH—, —CF═CF—, —C≡C—, —CH═CH—COO—, or —OCO—CH═CH— group, provided that oxygen, sulfur, and nitrogen atoms are not adjacent to one another,
P¹ represents a polymerizable group,
Sp¹ represents a C1-C6 linear, branched, or cyclic alkylene or alkyleneoxy group, or a direct bond,
m represents 1 or 2,
a dotted line between A¹ and Y and a dotted line between A² and Y represent an optional bond between A¹ and A² via Y, and
Y represents a —CH₂—, —CH₂CH₂—, —CH═CH—, —O—, —S—, —NH—, —N(CH₃)—, —N(C₂H₅)—, —N(C₃H₇)—, —N(C₄H₉)—, —OCH₂—, —CH₂O—, —SCH₂—, or —CH₂S— group, or a direct bond, and
a polymerizable monomer represented by Formula (II);
P³—S³-A³-(Z³-A⁴)ₙ-S⁴—P⁴ (II)
wherein
P³ and P⁴ may be the same as or different from each other, and each represent an acryloyloxy, methacryloyloxy, acryloylamino, methacryloylamino, vinyl, or vinyloxy group,
A³ and A⁴ may be the same as or different from each other, and each represent a 1,4-phenylene, 4,4′-biphenyl, naphthalene-2,6-diyl, phenanthrene-2,7-diyl, phenanthrene-3,6-diyl, phenanthrene-3,8-diyl, or phenanthrene-1,8-diyl group,
Z³ may be the same as or different from each other, and each represent a —COO—, —OCO—, —O—, —CO—, —NHCO—, —CONH—, or —S— group or a direct bond between A³ and A⁴ or between A⁴ and A⁴,
n represents 0, 1, 2, or 3,
S³ and S⁴ may be the same as or different from each other, and each represent a —(CH₂)ₘ— group (m representing a natural number satisfying 1≦m≦6), a —(CH₂—CH₂—O)ₘ— group (m representing a natural number satisfying 1≦m≦6), or a direct bond between P³ and A³, between A³ and P⁴, or between A⁴ and P⁴, and
a hydrogen atom on A³ and ⁴ may be replaced by a halogen or methyl group.

13. The method according to claim 12,
wherein the polymerizable monomer represented by Formula (I) is a polymerizable monomer represented by any one of Formulae (I-1) to (I-6); 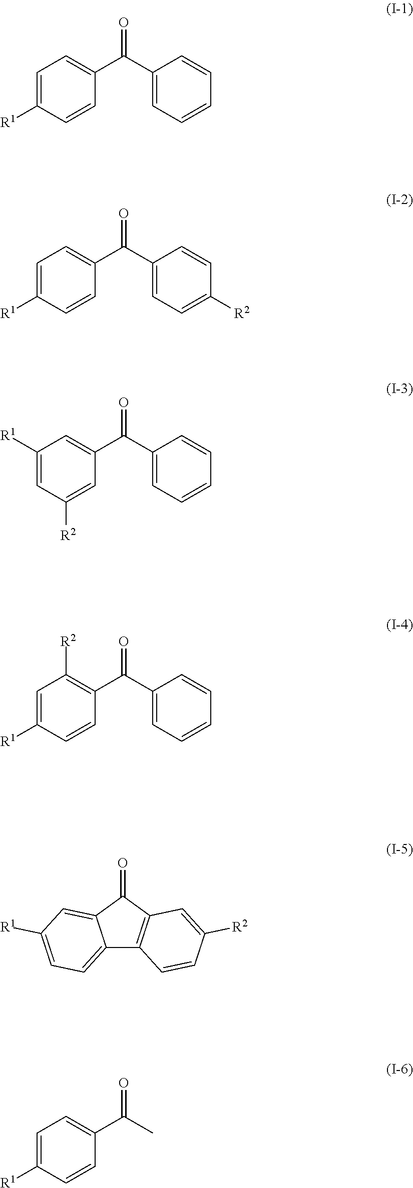
wherein
R¹ and R² may be the same as or different from each other, and each represent a -Sp¹-P¹ group, hydrogen atom, halogen atom, —CN group, —NO₂ group, —NCO group, —NCS group, —OCN group, —SCN group, —SF₅ group, C1-C12 linear or branched alkyl or aralkyl group, phenyl group, or biphenyl group,
at least one of R¹ and R² has a -Sp¹-P¹ group,
P¹ represents an acryloyloxy, methacryloyloxy, vinyl, vinyloxy, acryloylamino, or methacryloylamino group,
Sp¹ represents a C1-C6 linear, branched, or cyclic alkylene or alkyleneoxy group, or a direct bond,
when R¹ and R² each are a phenyl, biphenyl, or C1-C12 linear or branched alkyl or aralkyl group, a hydrogen atom on R¹ and R² may be replaced by a fluorine atom, chlorine atom, or -Sp¹-P¹ group,
a —CH₂— group on R¹ and R² may be substituted with a —O—, —S—, —NH—, —CO—, —COO—, —OCO—, —O—COO—, —OCH₂—, —CH₂O—, —SCH₂—, —CH₂S—, —N(CH₃)—, —N(C₂H₅)—, —N(C₃H₇)—, —N(C₄H₉)—, —CF₂O—, —OCF₂—, —CF₂S—, —SCF₂—, —N(CF₃)—, —CH₂CH₂—, —CF₂CH₂—, —CH₂CF₂—, —CF₂CF₂—, —CH═CH—, —CF═CF—, —C≡C—, —CH═CH—COO—, or —OCO—CH═CH— group, provided that oxygen, sulfur, and nitrogen atoms are not adjacent to one another.

14. The method according to claim 12,
wherein the polymerizable monomer represented by Formula (I) is a polymerizable monomer represented by any one of Formulae (I-7) to (I-8) mentioned below; 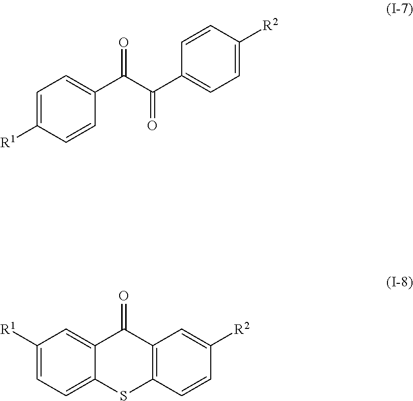
wherein
R¹ and R² may be the same as or different from each other, and each represent a -Sp¹-P¹ group, hydrogen atom, halogen atom, —CN group, —NO₂ group, —NCO group, —NCS group, —OCN group, —SCN group, —SF₅ group, C1-C12 linear or branched alkyl or aralkyl group, phenyl group, or biphenyl group,
at least one of R¹ and R² has a -Sp¹-P¹ group,
P¹ represents an acryloyloxy, methacryloyloxy, vinyl, vinyloxy, acryloylamino, or methacryloylamino group,
Sp¹ represents a C1-C6 linear, branched, or cyclic alkylene or alkyleneoxy group, or a direct bond,
when R¹ and R² each represent a phenyl, biphenyl, or C1-C12 linear or branched alkyl or aralkyl group, a hydrogen atom on R¹ and R² may be replaced by a fluorine or chlorine atom, or a -Sp¹-P¹ group,
a —CH₂— group on R¹ and R² may be substituted with a —O—, —S—, —NH—, —CO—, —COO—, —OCO—, —O—COO—, —OCH₂—, —CH₂O—, —SCH₂—, —CH₂S—, —N(CH₃)—, —N(C₂H₅)—, —N(C₃H₇)—, —N(C₄H₉)—, —CF₂O—, —OCF₂—, —CF₂S—, —SCF₂—, —N(CF₃)—, —CH₂CH₂—, —CF₂CH₂—, —CH₂CF₂—, —CF₂CF₂—, —CH═CH—, —CF═CF—, —C≡C—, —CH═CH—COO—, or —OCO—CH═CH— group, provided that oxygen, sulfur, and nitrogen atoms are not adjacent to one another.

15. The method according to claim 12,
wherein the step of forming a polymer layer includes polymerization of the two or more kinds of polymerizable monomers by irradiation of the liquid crystal layer with light of 330 nm or more.

16. The method according to claim 12,
wherein the step of forming a polymer layer includes polymerization of the two or more kinds of polymerizable monomers by irradiation of the liquid crystal layer with light of 360 nm or more.

17. The method according to claim 12,
wherein the step of forming a polymer layer includes polymerization of the two or more kinds of polymerizable monomers with application of a voltage of the threshold value or greater to the liquid crystal layer.

18. The method according to claim 12,
wherein the step of forming a polymer layer includes polymerization of the two or more kinds of polymerizable monomers with application of a voltage lower than the threshold value to the liquid crystal layer or without application of a voltage to the liquid crystal layer.

19. The method according to claim 12, further comprising the step of performing alignment treatment on the photoalignment film by irradiating the photoalignment film with light before the step of forming a liquid crystal layer.
